(19) United States
(12) Patent Application Publication
(10) Pub. No.: US 2015/0074268 A1
(43) Pub. Date: Mar. 12, 2015

(54) MEDIACARD SYSTEMS AND METHODS

(71) Applicant: Milyoni, Inc., Pleasanton, CA (US)

(72) Inventor: Dean Alms, Alamo, CA (US)

(21) Appl. No.: 14/480,577

(22) Filed: Sep. 8, 2014

Related U.S. Application Data
(60) Provisional application No. 61/874,900, filed on Sep. 6, 2013.

(51) Int. Cl. H04L 12/26

(52) U.S. Cl. CPC H04L 43/0876
USPC 709/224

(57) ABSTRACT

Embodiments of the invention are directed to methods, computer apparatuses, and systems for facilitating social interactions between multiple user computers and providing an interactive social experience for distributed viewers of media inputs over a communications network. Specifically, embodiments of the present invention are directed to generating, issuing, managing, trading, and displaying mediacards to a number of users through a reconfigured media presentation system.

### CROSS-REFERENCES TO RELATED APPLICATIONS

This application is a non-provisional of and claims the benefit of priority to U.S. Provisional Application No. 61/874,900, filed Sep. 6, 2013, which is hereby incorporated by reference in its entirety for all purposes.

### BACKGROUND OF THE INVENTION

Embodiments of the invention relate generally to viewing, interacting, and experiencing media content in a social media online environment. The rise of easy networking between computers and computing devices used by multiple people at disparate locations eventually led to the development of online social interaction, social networks and other activities that involve multiple people, typically at more than one physical location with interaction mediated via a network carrying data between clients, servers and nodes associated with various individuals and computers or computing devices.

Social media interactions might include interactions that are mediated by social media services that operate social media servers that connect users, such as the Facebook™ service, the Myspace™ service, the LinkedIn™ service, the Twitter™ service, and other online social-oriented membership and non-membership communities mediated by their respective services.

Generally, these online communities are made up of a plurality of registered users who provide information about themselves (or avatars) that are shared with other members who post information about themselves. Many services can be provided to these users through the social media website including the sharing of information, networking, dating, advertising, and the delivery of media.

As users engage more in social online interactions, there is more demand for more varied interactions, especially interactions directed at sharing information amongst users and otherwise interacting with one another.

Embodiments of the present invention solve these problems and other problems, individually and collectively.

### BRIEF SUMMARY OF THE INVENTION

Embodiments of the invention are directed to methods, computer apparatuses, and systems for facilitating social interactions between multiple user computers and providing an interactive social experience for distributed viewers of media inputs over a communications network. Specifically, embodiments of the present invention are directed to generating, issuing, managing, trading, and displaying mediacards to a number of users.

One embodiment of the present invention is directed to a method for issuing a mediacard to a user. The method comprises receiving a mediacard request from a user computer. The mediacard request may include an image identifier and a user identifier. The method further comprises determining a type of mediacard associated with the image identifier, identifying a user profile associated with the user identifier, and determining if the user qualifies for a mediacard associated with the image identifier. If the user qualifies for the mediacard, the method continues by generating a unique mediacard identifier for the mediacard. The unique mediacard identifier includes the image identifier and a unique sequence identifier. The method further comprises determining media content associated with the mediacard and sending a mediacard response including the mediacard to the user computer. The mediacard includes the unique mediacard identifier and the media content.

Another embodiment of the present invention is directed to a method for delivery of a mediacard to a user. The method comprises receiving a request for a media input from a user computer and determining a product identifier associated with the request. The method continues by determining mediacard offers associated with the product identifier and determining a trigger for each of the mediacard offers associated with the product identifier. The method continues by sending a response for the media input to the user computer and during playback of the media input to the user computer, monitoring for the trigger and displaying a mediacard offer at the trigger. The mediacard offer is displayed to the user for a limited time.

Another embodiment of the present invention is directed to a method comprising receiving a trade request from a user computer. The trade request includes a mediacard associated with an image identifier. The method continues by authenticating the mediacard. The method continues by determining a value for the mediacard dependent on performance of a subject matter of the mediacard, a total number of issued mediacards associated with the image identifier, and an interest level associated with the mediacard. The method then includes searching a database for mediacards associated with other users. The mediacards comprise an equal or lesser value than the user's mediacard. The method continues by sending the mediacards associated with other users to the user computer in a trade response, receiving a selection of at least one of the mediacards associated with the other users, and generating an exchange request and sending the exchange request to the owner of the at least one selected mediacards. The method continues by receiving an exchange response from the owner and if the owner agrees to the exchange, generating replacement unique mediacard identifiers for the mediacard and the at least one selected mediacard where the user identifiers for each mediacard are exchanged. The method then includes sending the updated mediacards to the user and the owner.

Another embodiment of the present invention is directed to a method comprising receiving two or more mediacards from a server computer and displaying a first mediacard on a display screen of a user computer. An image associated with an image identifier and a title is displayed on the display screen. The method continues by receiving a swipe input from the user to display a second mediacard, displaying the second mediacard on the display screen of the user computer, receiving a selection input from the user to select the second mediacard, and determining a link to a media input associated with the second mediacard. The method continues by sending a request for the media input associated with the second mediacard using the link and displaying an animation showing the second mediacard flipping over to show a backside of the mediacard. The backside of the mediacard includes a mediacard player. The method further comprises receiving the media input from the server computer and displaying the media input in the mediacard player displayed on the backside of the second mediacard.

Another embodiment of the present invention is directed to a method. The method comprises receiving a request to generate a mediacard including a type of mediacard, an image, and media content from a user computer. The method further comprises determining a link to a media input associated with the media content and determining mediacard effects associated with the type of mediacard. The method further comprises generating an image identifier associated with the mediacard and storing the mediacard in a mediacard database. The mediacard includes the image, the image identifier, the media content, the link to the media input, and the mediacard effects. The method further comprises updating a user profile of the user as being associated with the mediacard.

Additional embodiments include systems, user computers, server computers, and computer-readable medium comprising code, executable by a processor, for performing the methods described above.

These and other embodiments of the invention are described in detail below.

### BRIEF DESCRIPTION OF THE DRAWINGS

FIG. 1 shows an exemplary system for delivering mediacards to users through a reconfigured media presentation system, according to an exemplary embodiment of the invention.

FIG. 2 shows a flowchart of an exemplary method of issuing a mediacard to a user, according to an exemplary embodiment of the invention.

FIG. 3 shows an exemplary table showing the various types of mediacards and the relevant data entries that are stored in a unique mediacard identifier for each type of mediacard, according to an exemplary embodiment of the invention.

FIG. 4 shows a flow chart of an exemplary method for providing mediacard offers to a user during playback of a media input, according to an exemplary embodiment of the invention.

FIGS. 5 and 6 show an exemplary graphical user interface for mediacard issuance through a social video application associated with a reconfigured media provider during playback of a media input, according to an exemplary embodiment of the invention.

FIG. 7 shows an exemplary flowchart showing a mediacard trading exchange and point marketplace engaging in an exemplary method of trading a mediacard on the trading exchange, according to an exemplary embodiment of the invention.

FIG. 8 shows an exemplary graphical user interface of a collection of mediacards that may be received, stored, exchanged, and collected by a user, according to an exemplary embodiment of the invention.

FIG. 9 shows an exemplary method of displaying, experiencing, and interacting with mediacards on a user computer, according to an exemplary embodiment of the invention.

FIG. 10 shows an exemplary screenshot of a graphical user interface for browsing, interacting, and selecting mediacards as shown on a display screen of a user computer, according to an exemplary embodiment of the invention.

FIG. 11 shows an exemplary screenshot of a graphical user interface for browsing, interacting, and selecting mediacards as shown on a display screen of a user computer including some of the actions available to a user, according to an exemplary embodiment of the invention.

FIG. 12 shows an exemplary screenshot of a graphical user interface for of the backside of a selected mediacard as shown on a display screen of a user computer, according to an exemplary embodiment of the invention.

FIG. 13 shows another exemplary screenshot of a graphical user interface for of the backside of a selected mediacard as shown on a display screen of a user computer, according to an exemplary embodiment of the invention.

FIG. 14 shows an example of a computer system, according to embodiments of the present invention.

### DEFINITIONS

Prior to discussing embodiments of the invention, a further description of some terms can be provided for a better understanding of the invention.

A “user” may include any person or entity that interacts with a reconfigured media provider to view or interact with reconfigured media inputs. For example, a user may be a person that is registered to purchase, use, interact with, or view a movie through a reconfigured media presentation system. A user may also include a celebrity, moderator, persona, or other designated person that uses the social media presentment system to moderate, operate, direct, or otherwise has a special role outside of viewing or interacting with a media input. Additionally, in some embodiments, a user may include a marketing agent or other representative of a corporation configuring promotions, advertising, and other information to deliver through a reconfigured media system, social media networks, or any other entity associated with the reconfigured media presentation system.

A “user identifier” may include any unique identifier for a user of a system. For example, the user identifier may include a unique identifier for a registered user with an entity within a reconfigured media presentation system. The user identifier may be provided by a reconfigured media provider, social media network, a user, or any other entity in the reconfigured media presentation system. The unique identifier may uniquely identify a user for all purposes within a reconfigured media presentation system. Accordingly, the user identifier may be used to obtain information about a user request, past preferences, past activities, etc. associated with the reconfigured media provider, a social media network, or any other entity within the reconfigured media presentation system.

A “user account” may include a registered account at any entity within the social media presentation system. The user account may comprise any information that may be collected regarding the user. For example, the user account may include information provided during registration, information that may be collected from a user profile associated with the user at a social media website, information obtained from the user's interactions with a reconfigured media provider, or any other information that may be obtained from the reconfigured media provider or any other entity within the social media presentation system.

A “user profile” may include any information provided by a user regarding their interests, preferences, other users they know (i.e., friends, family members, etc.), or any other information they may provide an entity within the social media presentation system.

A “reconfigured media provider” may include any entity that incorporates, includes, generates, adds, or otherwise provides non-media inputs associated with a media input for presentation to users. The reconfigured media provider may provide the media input and the non-media input directly to a user or may link or otherwise provide information to the user regarding where they can find the reconfigured media input. For example, media inputs and non-media inputs may be stored and delivered by a computer associated with the reconfigured media provider or the computer of the reconfigured media provider may provide links or addresses to the media inputs and/or non-media inputs that are stored at a third party computer. A user device or user computer may then obtain the media input and/or non-media input from the third party computer associated with the links or addresses.

A “media content provider” may include any entity that produces content. For example, a media content provider may include a band, artist, production company, record label, sports franchise, sports league, advertising agency, corporation, or any other entity that generates content for user consumption. Typically, a media content provider may provide a media input to a content delivery network or other entity to convert the media input into a format that is capable of being transmitted across the internet or other communications networks to requesting user computers.

A “content delivery network” may include any entity configured to deliver media inputs to user computers. Typically, media content providers generate media inputs and provide the media inputs to content delivery networks to manage and deliver the media inputs to requesting user computers. Further, third parties may reference or otherwise provide a link to content provided by a content delivery network to user computers as a means for delivering content. For example, the reconfigured media provider may send a link to a media input that is stored on a content delivery network as part of the reconfigured media input that is delivered to a user computer. Additionally, content delivery networks may use various media players, content formats, and media files when delivering content to user computers and may be configured to provide media inputs in any number of different formats.

A “media input” may include a film, song, TV episode, sports plays, or any other digital media that is provided by a content provider. The media inputs can be delivered for educational, entertainment, safety, or any other information sharing purposes. The media input may be a live broadcast (i.e., a live “stream”) or a pre-recorded media event. The media input may be stored at a content delivery network and may be associated with a product stored by the reconfigured media provider.

A “non-media input” may include inputs that are generated by viewers (i.e. users), those experiencing the media, by the system administrator (e.g., event producer, organizer, etc.), or by entities associated with a media input (e.g., advertisers, content providers, etc.) and are not part of the originally generated presentation (e.g., concert, movie, sports game, etc.). Non-media inputs could include the actions of a viewer to interact with another viewer or the system before, during, or after the viewing of a media presentation. For example, non-media inputs could include comments made during the viewing of a movie or TV episode that are either shared with another viewer of the presentation or saved at a particular time in the media for later viewing by other users.

A “reconfigured media input” may include any reference to both a media input and the non-media input associated with the media input. Accordingly, the reconfigured media input may be a single file or communication including both the media input and the non-media input, may include the non-media inputs and links to the media input that may be provided by a content delivery network, may include only links to both the media input and the non-media input that are both provided by content delivery networks, or may include any combination thereof.

A “product identifier” may include any information that allows an entity to identify a reconfigured media input associated with a communication. For example, a product identifier may be a common identifier that is shared amongst all of the entities within the social media presentation system so that a media input, non-media inputs, or reconfigured media inputs may be identified by any of the entities within the social media presentation system. Alternatively or additionally, the product identifier may be an independent identifier associated with the reconfigured media provider and identifying a particular media input or content associated with a media input.

A “request” may include any message or series of messages sent from a client computer to a server computer for any information. For example, a mediacard request may include a request for a mediacard to be generated, issued, or displayed by a user computer. The request may include any information that may allow the server computer to provide the information being requested by the client computer. For example, a mediacard request may include a user identifier and an image identifier to allow a reconfigured media provider computer to determine a reconfigured media input, mediacards, and a user account associated with the request.

A “mediacard” may include any data associated with media content that is configured to be provided to a user computer or device. A mediacard may include any type of media content. For example, a mediacard may include a video card, audio card, promotional card, engagement card, or any other type of mediacard that includes a particular type of data or media. For instance, a video card may include a link to a media input or may include the media input itself.

In some embodiments, a mediacard may comprise a format including an image that is displayed on the face of the mediacard and which may be configured to have a particular mediacard effect when selected by a user. For instance, a mediacard may be displayed as a picture of a main character of a movie in a card or other rectangular or box-like format. When a user touches or otherwise selects the image, the mediacard may flip-over or otherwise transition to show the back of the mediacard. The “backside” or the second view of the mediacard may provide additional information about the subject matter of the mediacard, provide options for a consumer to further interact with the subject matter, and/or be configured to allow a consumer to perform a mediacard effect (e.g., play a video, song, or other media input associated with the mediacard). Additional mediacard effects include collecting, sharing, following, playing content, controlling the playback or interaction of content, interacting with the subject matter of the mediacard (e.g., answering polls and quizzes and receiving answers, facts, quotes, etc., associated with the product or media input associated with the mediacard), linking to relevant shopping, commercial, and other websites, advertisements, offers, coupons, events, and sponsorship information.

A “response” may include any message or series or messages sent from a server computer to a client computer that provides information requested in the request message. For example, a mediacard response may provide a mediacard to be displayed by a user computer or user device.

A “user computer” or “user device” may include any device configured to communicate with other devices or computers. The user computer may be portable or stationary. For example, a user computer may include a desktop computer, a laptop, a mobile phone, a tablet, a smart watch, or any other device that is configured to be used by a user to communicate with other devices. A user computer or user device may be configured to communicate over any number of communication networks including the internet, mobile communication networks, etc. The user computer or user device may comprise a processor and a computer-readable medium comprising code, executable by the processor, configured to perform any number of functions and features described herein.

### DETAILED DESCRIPTION OF THE INVENTION

Embodiments of the present invention are directed to methods and systems that facilitate social media viewing of media inputs where the presentation may be synchronized by user devices that are located in many different locations but allow users to input non-media related inputs to current and/or subsequent viewers. Specifically, embodiments of the present invention are directed to generating, issuing, managing, trading, and displaying mediacards to a number of users.

Mediacards provide an easy, responsive, interactive, easily customizable, and engaging platform for targeting, delivering, displaying, and communicating with consumers, fans, friends, social media users, and any other users of a reconfigured media presentation system. For example, mediacards provide a quick and easy format for sifting through large amounts of media without requiring download of large portions of media content until a user has selected the content. The mediacards allow a consumer to determine whether a topic is interesting to them, whether they would like to know more about a topic, and quickly and easily experience interesting content or move on to other content without delay.

Mediacards provide a seamless viewing experience where consumers may obtain a large amount of information about a product or subject in a short period of time while being provided the opportunity to interact with other users. Further, the mediacard platform drives consumer interaction and engagement with products, media inputs, or their interested subjects. For example, mediacards can easily be shared and/or published on multiple social media networks that push additional users to products and advertise the interests of users to their peers. Users may generate their own custom mediacards and publish the mediacards to their friends and social networks quickly and easily as well as combine multiple mediacards into mediacard stories for use in providing insight into a consumer's interests, experiences, and stories in a user-friendly and intuitive format. Accordingly, mediacards may be used by users to tell stories and inspire interaction, engagement, and sharing amongst their peers and friends.

### I. Reconfigured Media Presentation System

Embodiments of the present invention may utilize a reconfigured media presentation system that is configured to allow users connected through the internet or other communication network to interact with a reconfigured media provider system in order to experience reconfigured media inputs including media inputs and non-media inputs. For example, the system may allow individual users or groups of users to watch a movie, TV show, live concert, or other media event at the same time from different devices in multiple locations. The system may allow users to post comments and chat amongst segmented viewers and all viewers, ask celebrities questions, purchase products or services from advertisers or those products and services that are relevant to the media input (e.g., event), participate in polls related to the media viewing experience, take quizzes relevant to the viewing experience, share content related to the media input, or otherwise interact with the online event. Additionally, the system can provide a virtual theater experience where groups of users can meet on a social media website using their electronic devices at numerous different locations and engage in a social activity centered on the media. Further, users may use the system individually to have an interactive experience with any media input in order to create a community with people of similar interests from around the world.

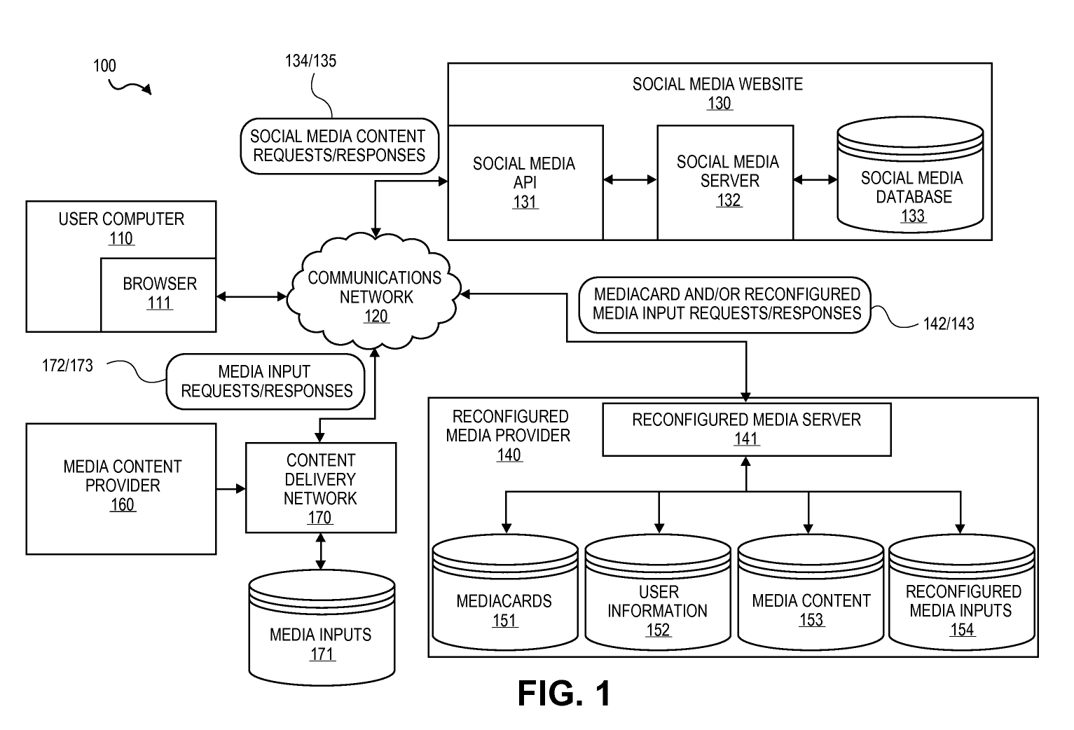

FIG. 1 shows an exemplary reconfigured media presentation system 100 for delivering reconfigured media inputs and mediacards to user computers 110, according to one embodiment of the invention. The reconfigured media presentation system 100 comprises a user computer 110, a reconfigured media provider 140, a social media website 130, and a content delivery network 170. All of the above entities may be coupled to a communications network 120 that allows each of the entities to send and receive communications to and from other entities, computers, etc.

The reconfigured media presentation system 100 may allow user computers 110 to request and receive reconfigured media inputs that include both media inputs (e.g., movies, videos of plays, concerts, recordings of music, etc.) along with non-media inputs (e.g., chat messages, poll questions, trivia, questions and answers, etc.) related to the media input. For example, a media content provider 160 may provide a media input to a content delivery network 170 for distribution to user computers 110 through a communications network 120. The content delivery network 170 may reconfigure and store the media input for future delivery. The media input may either be an encoded file of a prior performance, recorded video, recorded event, or a live video feed of a performance or event that may be encoded by the content delivery network 170. The content delivery network 170 may use a media application to reconfigure the media input to a format that can be streamed from the content delivery network 170 to users that request the media input via a social media website 130, reconfigured media provider 140, or directly from the content delivery network 170. In some embodiments, the functionality provided by the content delivery network 170 may also be accomplished by the reconfigured media provider 140 which may host the media inputs directly or may reconfigure the media inputs for distribution and provide them to other content delivery networks (not shown), etc.

The media content provider 160 may also provide the media input to a reconfigured media provider 140 that may generate and/or configure non-media inputs associated with the media input in a reconfigured media input. The reconfigured media input may include non-media inputs that allow users of a social media website 130, the reconfigured media provider 140, or any other third party website to interact with the media input through the user of sharable clips, quotes, songs, and annotated chat. The non-media input options can be added using the social media website's application programming interface (API) 131. The reconfigured media input may include the link to the media input hosted at the content delivery network 170 such that when a reconfigured media input is sent to a user computer 110, the user computer 110 may contact the content delivery network 170 for the media input associated with the non-media inputs by sending a media input request 172. The non-media inputs, APIs for each media input, and the links to the appropriate media inputs at various content delivery networks may be stored in a reconfigured media inputs database 154 at the reconfigured media provider 140. In some embodiments, the reconfigured media provider 140 could also be provided the reconfigured media from another party (not shown) or the media content provider 160 could reconfigure the media prior to providing it to the reconfigured media provider 140.

After generating a reconfigured media input, the reconfigured media server 141 may receive a reconfigured media input request from a user computer 110 to view the media input. Alternatively, the reconfigured media server 141 could receive a reconfigured media request 142 from the social media website 130 to stream the media input to a particular user computer 110. The reconfigured media input may be provided through a communications network 120 to a browser 111 operating on a user computer 110. The social media API 131 may allow users to interact with each other using the application programming interface (API) of each social media website 130. Therefore, a different reconfigured media input can be created for different social media websites 130 with different APIs embedded.

The social media API 131 also allows the reconfigured media server 141 access to the user's profile information on the social media database 133 of the social media website 130. The reconfigured media server 141 can also require the user to log in order to determine the user's profile information that is stored by the reconfigured media provider 140 at a user information database 152. Each user account may be identified by a unique user identifier.

The reconfigured media server computer 141 can create a secure connection or “handshake” with the social media website 130 and deliver the reconfigured media input to the user computer 110. Accordingly, a user may now interact with the reconfigured media input and may provide non-media input relevant to other users viewing the reconfigured media input.

The reconfigured media server computer 141 may comprise modules for verifying the identity of a requesting user computer 110, sending requests and receiving responses for user profile information from the social media server 132 and social media API 131 stored on the social media database 133 corresponding to the identity of the requesting user (e.g., user identifier associated with the user) at the user computer 110, storing the user information in a user information database 152, receiving mediacard and/or reconfigured media input requests 142, generating and storing a mediacard in a mediacards database 151 in response to a user request for generation of a new mediacard, conversion of existing media content into a mediacard, or mediacard generation requests from content providers (e.g., media content provider 160, advertisers, production companies, marketing companies, etc.), generating a mediacard and/or reconfigured media input response 143 configured to display on the browser 111 of the user computer 110 in response to the request, including the reconfigured media input and non-media inputs related to social features, and storing media content associated with mediacard requests in a media content database 153.

The mediacards database 151 may comprise any relevant information associated with generated and/or issued mediacards. For example, the mediacards database 151 may comprise a record for each mediacard generated by and/or provided to the reconfigured media provider server computer 141. A mediacard record, template, configuration parameters, and/or entry may include any relevant information to allow for the reconfigured media provider 140 to determine the type of mediacard, the configuration parameters associated with the mediacard, the image, the reconfigured media inputs (e.g., media input and non-media inputs) associated with the mediacard, and any other information for delivering and/or issuing a mediacard to a user.

For example, the mediacards database 151 may comprise a plurality of mediacard entries including an entry for each mediacard generated by the reconfigured media provider 140 with each entry including information regarding the source of the media input, the creator or original provider of the mediacard, an image associated with the mediacard, the number of issued mediacards for the mediacard, the authorization identifier to identify the entity with rights to the underlying copyrighted graphic, image, or media content, and the users associated with the mediacard or having mediacards associated with the entry issued to them. Any other suitable information may be stored as well including non-media inputs (e.g., chats, quotes, engagements, etc., associated with the mediacard as well as any other relevant information. Additionally, mediacard offers and configuration information for triggers, etc., may be stored in the mediacards database 151 for each mediacard.

The user information database 152 may comprise any relevant information to users of the reconfigured media presentation system. For example, the user information database may include personal information (e.g., consumer name, address, etc.), financial information (e.g., credit card number, expiration date, etc.), account information (e.g., username, password, authentication information, etc.), transaction history (e.g., past reconfigured media inputs or products ordered, viewed, etc.), and profile information (e.g., mediacards generated, issued, delivered, trigger conditions associated with the mediacards, etc., to the user) associated with a user.

In some embodiments, the user information may further comprise a portfolio of mediacards associated with a user profile as well as mediacard stories generated by the user and stored at the user information database or the mediacards database. For example, when a mediacard is generated, the mediacard may be issued to a user and a mediacard identifier may be stored in a mediacard personal portfolio area of the user information database and/or the issued mediacards may be stored in the mediacards database 151 with user identifiers identifying those users with issued mediacards.

The media content database 153 may comprise images, image identifiers, media inputs, links to media inputs stored at a content delivery network 170, and any other relevant information to a reconfigured media input or a mediacard generated and/or stored by the reconfigured media provider 140. The media content may be provided by a media content provider 160, a content delivery network 170, a user, advertisers, and any other relevant entities.

The reconfigured media inputs database 154 may comprise media inputs and non-media inputs associated with products (e.g., reconfigured media inputs) provided by the reconfigured media provider 140. For example, in some embodiments, the reconfigured media inputs database may comprise the non-media inputs associated with a mediacard. For instance, the chats, engagements (e.g., polls, quotes, etc.), etc., provided with a mediacard (and subsequently displayed to a user) may be stored and extracted from non-media inputs stored in the reconfigured media inputs database 154 and associated with the mediacards being delivered in response to a user request.

Additional information regarding the functionality and capabilities of the reconfigured media presentation system may be found in U.S. patent application Ser. No. 13/961,783, titled “Methods and Systems for Linking and Prioritizing Chat Messages,” filed Aug. 7, 2013, U.S. patent application Ser. No. 14/065,338, titled “API Translator for Providing a Uniform Interface for Users Using a Variety of Media Players,” filed Oct. 28, 2013, and U.S. patent application Ser. No. 14/475,369, titled “Systems and Methods for Predicting and Characterizing Social Media Effectiveness,” filed Sep. 2, 2014, all of which are assigned to the same assignee as the present application and all of which are hereby incorporated by reference in their entirety for all purposes.

### II. Methods of Generating and Issuing Mediacards

Embodiments of the present invention are configured to allow different entities to generate, issue, select, collect, and distribute mediacards, mediacard offers, and mediacard stories to a variety of different entities within the reconfigured media presentation system. Mediacards may be generated by configuring the parameters, underlying image, media inputs, type, and details for a mediacard. The mediacard may thereafter be issued to one or more users depending on the type of mediacard (limited, unlimited, exclusive, etc.) and the issuance conditions to be met in order to issue mediacards to a user. Mediacards may be generated by users, media providers, advertisers, and any other relevant or interested parties. The mediacards may be generated through a mobile device, desktop user computer, or any device configured to obtain media content and deliver the media content along with mediacard configuration parameters to the reconfigured media provider server computer 141. Additionally, embodiments allow users to select pre-existing mediacards to combine, collect, and package various mediacards into a mediacard story that can easily be shared to provide a narrative or story to friends, family, consumers, and any other relevant entities associated with the reconfigured media presentation system.

A. Methods for Generating Mediacards

Embodiments of the present invention may be configured to allow a user to generate, select, and organize media inputs into one or more mediacards, one or more mediacards into mediacard stories, and one or more mediacard stories into a mediacard catalog based on the preferences and customization of users.

For example, a user may generate a mediacard by sending a request to generate a mediacard to a reconfigured media provider 140 from the user computer 110 (e.g., desktop computer, mobile device, etc.). Before generating the mediacard, the user may log-in to their account at the reconfigured media provider 140 using authentication information (e.g., username, password, etc.) so that the reconfigured media provider server computer 141 may determine the user profile in which to associate with the mediacard. The user profile may include a commercial account for users that are associated with advertisers, companies, etc.

A mediacard generation request may include a type of mediacard to generate, an image for the mediacard, and media content associated with the mediacard. For example, the type of mediacards may include a type of media associated with the card (e.g., video, audio, engagement, advertisement, etc.), a publication setting for the mediacard (e.g., private, public, triggered, etc.), the number of mediacards that may be issued (e.g., unlimited, predetermined number, etc.) and the value of the mediacard (e.g., valid as a ticket for entrance to an event, worth a monetary amount, etc.). The request to generate the mediacard may further comprise publication conditions (e.g., triggers configurations, user targeting, reconfigured media inputs associated with the mediacards, etc.), and any other relevant information for targeting, issuing, and providing mediacards associated with the mediacard generation request. For instance, a type of mediacard may include a video card, an audio card, an engagement card, a promotion card, an exclusive card (e.g., limited in number and typically valuable), a personal card (e.g., generated by a friend or other private user or consumer and having a private status or restricted publication status), and a profile card (e.g., a mediacard including information about users on the reconfigured media provider system or social media networks).

A reconfigured media provider server computer 141 may determining a link to a media input associated with the media content. For example, the reconfigured media provider 140 may validate the existence of a link to the media input identified by a user, may post or generate a new link to the media input stored at a content delivery network 170 or internally at the reconfigured media provider 140, or may search for media inputs associated with an identified event on partner content providers to determine a more appropriate, preferred, or higher quality media input for the mediacard.

The reconfigured media provider 140 may determine the mediacard effects associated with the type of mediacard being requested by the user. The mediacard effects may be determined based on the parameters, conditions, and type of mediacard being requested. For example, a mediacard generation request for a video type of mediacard with limited issuances and no value may include the mediacard effects of video playback, video configuration, sharing and/or posting to multiple social media networks, comments, engagements, and any other relevant information that may be provided during display or viewing of a mediacard.

The reconfigured media provider 140 may store the received image in the media content database and may generate an image identifier associated with the mediacard. The image identifier may be unique for each mediacard generated and stored in the mediacard database and thus, may be used as a unique identifier for determining the mediacard parameters associated with a mediacard request and for searching for the relevant mediacard entry stored in the mediacard database.

The reconfigured media provider server computer 141 may store the mediacard in a mediacard database as a new mediacard entry and may populate the mediacard with any and all available information associated with the mediacard. For example, the mediacard entry may include the image, the image identifier, the media content, the link to the media input, and the mediacard effects associated with the mediacard. Further, the mediacard entry may include a link to one or more related reconfigured media inputs (i.e., products) provided by the reconfigured media provider 140 as well as non-media inputs associated with those products (e.g., chat messages, engagements, advertisements, etc.). Accordingly, the reconfigured media provider 140 may extract and include the non-media inputs (e.g., chats, engagements, advertisements, etc.) associated with the reconfigured media input with the content of the mediacard when delivered to a user for viewing. Because the non-media inputs are updated periodically, the content provided by the reconfigured media input for a particular mediacard may change to include new chat comments, engagements, etc. as mediacards are delivered or viewed by users that have been issued a particular mediacard.

The reconfigured media provider server computer 141 may further update a user profile of the user as being associated with the mediacard to indicate that the consumer or a user generated the mediacard.

B. Methods for Generating Mediacard Stories and Mediacard Catalogs

Additionally, users may generate mediacard stories that include multiple mediacards, narrative information surrounding the mediacard, customizable transitions between mediacards, etc. A user may generate a mediacard story by a user selecting two or more pre-generated mediacards for distribution together as a single story or media packet.

For example, a reconfigured media provider 140 may receive a selection of two or more mediacards as being associated with a mediacard story from a user computer 110. The mediacard story may also have a trigger condition associated with the mediacard story that allows the mediacard story to be shared and/or targeted to particular users meeting a set of conditions, activities, and/or interests.

The reconfigured media provider 140 may monitor other users for actions that meet the trigger condition, determining that at least one of the other users meet the trigger condition, and send the mediacard story to the at least one of the other users that meet the trigger condition. The trigger conditions may include any relevant information associated with a user or reconfigured media input associated with a user. For example, the trigger condition may include a user performing an action associated with the reconfigured media input (e.g., requesting to watch a particular product, chatting about a product, friending or otherwise showing interest in a particular product, etc.), a user traveling within a proximity of a predetermined geographic location associated with the mediacard or mediacard story (i.e., location-based triggering), a performance or status of a user (e.g., a user obtaining a particular status, number of loyalty or interaction points, interacting with a particular engagement, etc.), and a playback time of a media input (e.g., reaching a particular point in a reconfigured media input playback). Accordingly, users and content providers may configure mediacards and mediacard stories to be delivered and offered to users based on targeted performance and information about users within the reconfigured media presentation system.

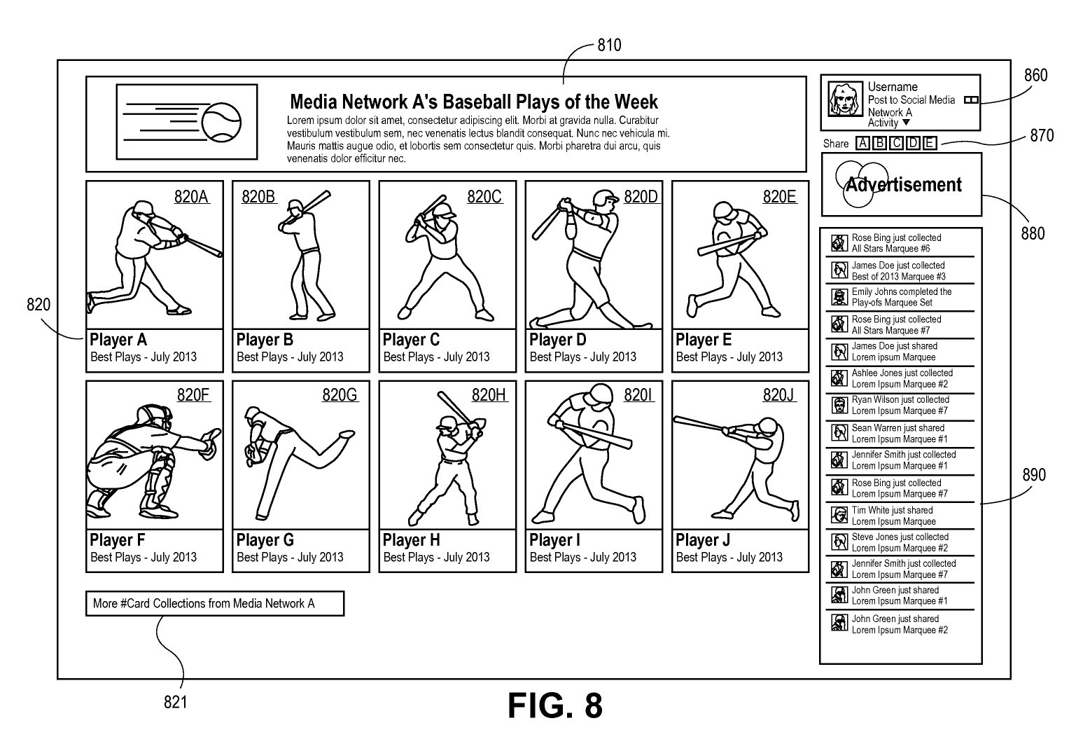

Furthermore, when a mediacard is issued to a user, the issued mediacard information may be stored or associated with the user's profile in a mediacard collection. A user may have one or more mediacard collections that may be organized by subject matter, time, whoever generated the card (e.g., content providers vs. user-created), status (e.g., public vs. private), and any other relevant differentiating information. Additionally, mediacard stories may be stored in the collections along with individual mediacards. FIG. 8 shows an exemplary mediacard collection associated with “media network A,” and shows how mediacards and mediacard stories may be organized and provided according to subject matter and relevance.

C. Methods for Issuing Mediacards

Where the mediacard is issued to a particular user, the user profile or a user collection of mediacards associated with the user profile may include a unique mediacard identifier that is generated for the issued mediacard being associated with the user as well. For example, during issuing of a mediacard, a user either interacts with a mediacard offer or selects a mediacard that looks interesting to a user in order to obtain additional information and save the mediacard to the consumer's mediacard collection. The reconfigured media provider 140 may generate a unique mediacard identifier associated with the user for the mediacard, for example, including the user identifier in the mediacard unique identifier, and may store the unique mediacard identifier to the user profile of the user. The contents of the generated mediacard unique identifier depends on the type of mediacard being issued.

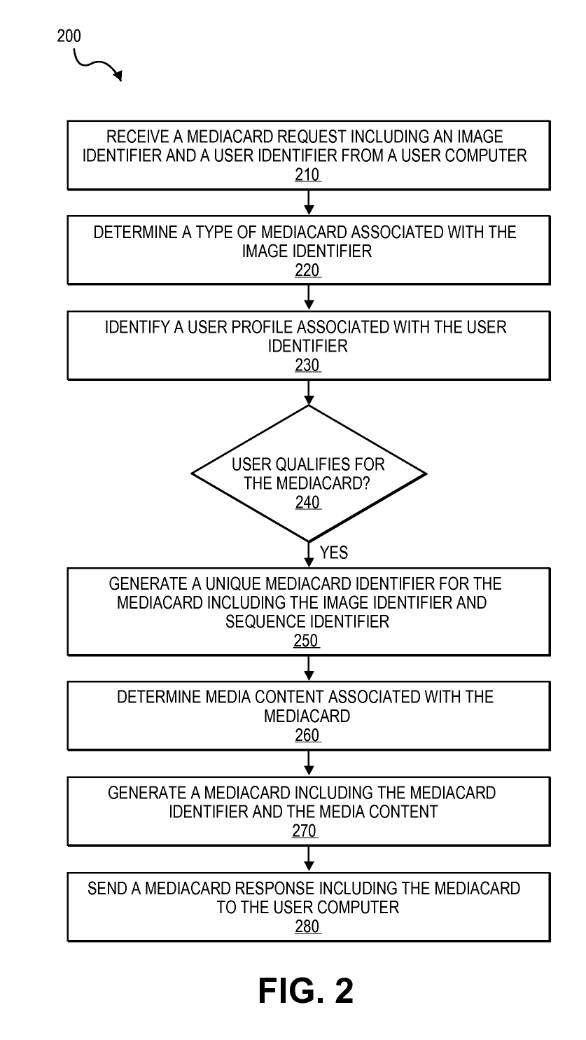

FIG. 2 shows an exemplary method of issuing a mediacard to a user by the reconfigured media presentation system shown in FIG. 1. The exemplary method may be performed by a reconfigured media provider 140 and before the method shown in FIG. 2, a reconfigured media provider 140 may already be interacting with the user in a number of ways. More details regarding how mediacard offers can be provided to the user and how mediacard requests are generated by a user may be provided in more detail regarding how mediacards are delivered to users in the next section.

At step 210, a reconfigured media provider 140 may receive a mediacard request from a user computer 110. The mediacard request may include an image identifier and a user identifier. The image identifier may include an image that is associated with a mediacard and is displayed on the front of the mediacard. Accordingly, each generated mediacard may have a different image or different image identifier for the image. Therefore, it may be possible to have the same perceivable image on two separate mediacards but two separate mediacards where unique image identifiers are stored in separate sections and associated with different users on the mediacards database of the reconfigured media provider 140. The user identifier may be embedded into the mediacard request when the user asks for the mediacard to be generated. For example, a mediacard request may be generated when a user interacts with a time-limited graphical mediacard engagement that is provided through a video player provided by a reconfigured media provider 140. More details regarding the various circumstances and situations that may lead to a mediacard request being generated may be described in more detail in the delivery method section below.

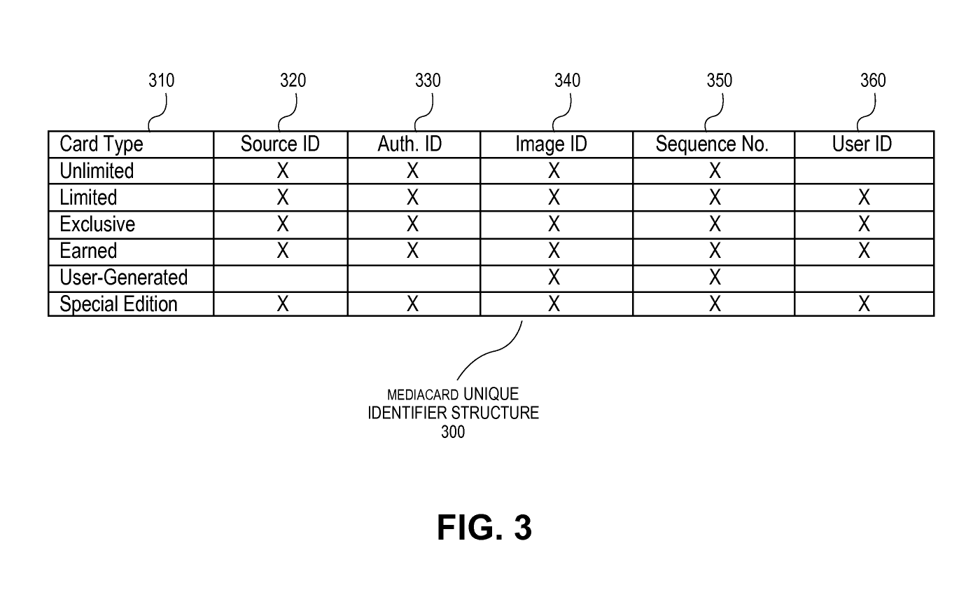

At step 220, a reconfigured media provider 140 may determine a type of mediacard associated with the image identifier. The reconfigured media provider 140 may determine the type of mediacard by searching a mediacards database for a mediacard associated with the received image identifier and determining the type of mediacard associated with the mediacard entry. The different types of mediacards may include an unlimited mediacard, a limited mediacard, an exclusive mediacard, an earned mediacard, a user-generated mediacard, and/or a special edition mediacard. FIG. 3 shows an exemplary table showing the various types of mediacards and the relevant data entries that are stored in a unique mediacard identifier for each type of mediacard. The mediacard identifiers may be stored in the mediacard database along with the type of mediacard and other information that is used to generate the mediacard (e.g., the number of mediacards that may be issued, etc.). The image associated with the image identifier or a link to a location where the image identifier may be located may also be stored in the mediacard database. Additional mediacard related information (e.g., trigger conditions, card issuance limits, a mediacard type identifier, configuration parameters, etc.) may also be stored in the mediacard database for the mediacard and may be used in determining the type of mediacard associated with the image identifier.

The type of mediacard may be determined from the mediacard entry through any suitable manner. For example, each type of mediacard may be associated with a different mediacard type identifier (e.g., “U” or “01” for unlimited, “L” or “02” for limited, “E” or “03” for exclusive, etc.) that may be included in a mediacard type field for each mediacard included in the mediacard database. Additionally or alternatively, the type of mediacard may be determined by comparing the configuration parameters of the mediacard associated with the received image identifier to mediacard parameters associated with each type of mediacard. For example, a limited mediacard may include configuration parameters that include a maximum number of mediacards that may be issued while an unlimited mediacard may not have a maximum number of mediacards that may be issued. Additionally or alternatively, various parameters may be combined in order to determine other types of mediacards. For example, an exclusive mediacard may include an issuance limitation as well as require trigger conditions that may be associated with an exclusive user (e.g., performance or account based trigger conditions).

At step 230, a reconfigured media provider 140 may identify a user profile associated with the user identifier. The user database may be searched for a user profile associated with the user identifier received in the mediacard request. Accordingly, the reconfigured media provider 140 may determine personal information for the user associated with the request, other mediacards the user may have been issued, and any other information about the user (e.g., order history, preferences, previous trades, etc.).

At step 240, a reconfigured media provider 140 may determine whether the user qualifies for the mediacard being requested. In various embodiments, the reconfigured media provider 140 may use the information in the user profile to determine if the user already has too many mediacards, if the request is too late (e.g., after a mediacard offer for the mediacard has expired or if all of the available mediacard offers have been filled, whether the user profile or user account is in good-standing, etc.).

At step 250, if the user qualifies for the mediacard, the reconfigured media provider 140 may generate a unique mediacard identifier for the mediacard. The unique mediacard identifier may include the image identifier and a sequence number associated with the image identifier. Depending on the type of mediacard being generated (e.g., limited or unlimited, exclusive, earned, user-generated, or a special edition) the unique mediacard identifier may include additional information including a source identifier, an authorization identifier, and a user identifier. A source identifier may include an identifier that designates any application, game, or brand that is generating the Mediacard. An authorization identifier may include any identifier of an organization with the rights to the content. An image identifier includes any identifier of the image associated with the mediacard. A sequence number includes any identifier for the specific sequence number of the mediacard. A user identifier may include any identifier for the user and mediacards acquired by an individual are assigned their user identifier.

The unique mediacard identifier may be used to authenticate a mediacard or authenticate any communication related to a mediacard (e.g., request for media input related to the mediacard, an exchange, a trade, etc.). Accordingly, each mediacard that is issued by the reconfigured media provider 140 (or any other entity) may generate a unique mediacard identifier associated with the issued mediacard. The unique mediacard identifier may be encrypted, tokenized, or otherwise protected such that the unique mediacard identifier may not be easily manipulated or reproduced. As such, the possession and authenticity of a mediacard by a user may be authenticated, verified, or validated for any and all purposes. For example, during a trade request associated with a mediacard, a unique mediacard identifier may be provided to the reconfigured media provider 140 as proof that the consumer owns a mediacard. The reconfigured media provider 140 may authenticate the presented mediacard by comparing the unique mediacard identifier to issued mediacards associated with the mediacard in a mediacard database to ensure that the unique mediacard identifier was issued, the user identifier associated with the unique mediacard identifier, and the user identifier of the user.

At step 260, a reconfigured media provider 140 may determine media content associated with the mediacard. Media content may comprise a media input (e.g., video, trailer, game, etc.), a link to a media input stored at a third party (e.g., a content delivery network 170 storing the media input), and/or non-media inputs (e.g., engagements, text including title, stats, an achievement associated with the subject matter or entity), or any other relevant information associated with the media input. Further, the link to the media input being stored by a third party may be specific to the individual unique mediacard identifier and the user requesting the media input may provide the unique mediacard identifier in order to gain access to the media input (be authenticated to the third party). Alternatively, the reconfigured media input may act as an intermediary between the third party and the user and may provide the unique mediacard identifier to the third party.

At step 270, a reconfigured media provider 140 generates a mediacard including the mediacard identifier and the media content. The reconfigured media provider 140 may store the unique mediacard identifier, media content, user identifier, and any other relevant information in the mediacard database. Accordingly, the unique mediacard identifier may be stored and used as an access credential for the link to the media input, non-media inputs, access to request services, discounts, or other related information relative to the mediacard, etc.

At step 280, a reconfigured media provider 140 may send a mediacard response including the mediacard to the user computer 110. The mediacard may be provided through any suitable method including a physical file that is provided to the user and stored in a specific file on the user computer 110. Alternatively, the mediacard links and pointers may be provided to the user (including the unique image) and then the user may contact the media provider when accessing a mediacard to play a video, share a media input associated with a mediacard with a friend, etc.

D. Card Authentication/Contents of Mediacards

Mediacards may include any number of elements including a unique mediacard identifier. The unique mediacard identifier may be generated at the time the mediacard is issued and may be assigned to a particular user associated the mediacard being generated. The unique mediacard identifier may be used as an authentication credential that each entity within the social media presentation system that handles a mediacard may validate with the reconfigured media provider 140 (or local database of mediacards) before completing a requested task.

1. Every Issued Mediacard is Unique and Tied to User Identifier

When a mediacard is generated or issued by the social video player application, a mediacard credential may be generated that uniquely identifies each mediacard generated by the digital trading mediacard platform. The mediacard credential may be managed by the reconfigured media provider 140 such that only one specific instance of a mediacard may be active at any one time (e.g., one active mediacard for each specific mediacard identifier). For example, a mediacard may be “checked out” or another indication may be provided such that any entity working with the mediacards may determine that a mediacard is being used or operations related to the mediacard are occurring at a given time. Accordingly, mediacards may not be duplicated and used on the system. A mediacard may be tracked, used, or managed by the system via authentication of the unique mediacard identifier. This is advantageous because duplicated, reproduced, or counterfeit mediacards may not be accepted by the system.

For example, in some embodiments, a mediacard authentication value may comprise a unique image number, user identifier, and a sequence number. The reconfigured media provider 140 may combine these elements in any suitable fashion in order to create an encrypted algorithm or other authentication credential. Accordingly, no two mediacard identifiers will be the same. Furthermore, if a mediacard is copied through a screen capture or other reproduction, the mediacard may not comprise any value and the system may not recognize the reproduced image or videoclip as a mediacard, due to the lack of the unique mediacard identifier as an authentication credential. As such, a reproduced mediacard may not be used to interact with a media input (since a content delivery network 170 may authenticate a mediacard credential before providing a media input), may not have the ability to exchange or submit a mediacard to a trading exchange, and may not be provided any value.

Further, if a mediacard credential is reproduced, the mediacard may not be used by a different user identifier than the user identifier associated with the mediacard. Accordingly, a mediacard may only be used if a user identifier associated with the mediacard matches the user identifier associated with a mediacard service request.

Furthermore, even if the mediacards are provided by third parties, sent through third party systems, etc., the reconfigured media provider 140 may still receive an authentication request from some entities or the reconfigured media provider 140 may provide a mediacard authentication database to any entity that services requests related to a mediacard. Accordingly, sponsor or other platforms that may host mediacard content or provide mediacard generation opportunities to users (e.g., a partner that allows users to receive mediacards as part of a promotion in order to drive traffic to their website, location, etc.) may use an embedded reconfigured media provider application that communicates with the reconfigured media provider 140 to authenticate users, mediacards, etc. before providing any services.

2. Card Authentication Based on User Identifier

The digital trading mediacard platform may be provided through reconfigured media provider's social video player application which requires a user is authenticated as a registered user or that a user sign up for a user account before any application functionality is provided. Accordingly, each user may have a unique user identifier and mediacards may be issued, stored, and managed using the unique user identifier. As such, users who attempt to trade or exchange mediacards that are not associated with their user identifier (i.e., counterfeit mediacards) will not be successful.

3. Unique Image Identifier

The mediacard credential may include a unique image identifier that associates a mediacard with a particular character, sports player, actor, organization, etc. Each player, character, organization may have multiple mediacards issued but each mediacard will have a unique image identifier that associates that character, player, actor, organization, etc. with a particular event, game, date, product release, image, etc.

4. Unique Mediacard Sequence Identifier

The mediacard credential may further include a unique sequence identifier for each image identifier. Accordingly, limited releases of mediacards may be facilitated such that, for example, only 100 mediacards may be generated for a particular event, game, etc., and only the first 100 users that claim the mediacard will have the opportunity to obtain the mediacard. mediacard with unlimited numbers may still implement a sequence number that uniquely identifies the mediacard for tracking and mediacard management purposes. This is advantageous because mediacards may be limited in order to provide incentives for users to interact with the system as quickly as possible and to stay engaged with the subject matter or entity that is the subject of the mediacard.

5. Use of Unique Identifiers

Authentication may be performed at various times including when any mediacard is requested, a trade request or other exchange is ordered, or any other time it may be relevant to determine that the user is the correct user that was originally issued the mediacard.

FIG. 3 shows an exemplary table showing the various types of mediacards 310 and the relevant data entries that may make up a portion of a mediacard unique identifier structure or format for each type of mediacard. Mediacards may comprise a source identifier 320, an authorized identifier 330, an image identifier 340, a sequence number 350, and a user identifier 360.

A source identifier may include an identifier that designates any application, game, entity, corporation, or brand that is generating the mediacard. An authorized identifier 330 may include any identifier of an organization with the rights to the content. An image identifier 340 may include any identifier of the image associated with the mediacard. A sequence number 350 may include the number of the issued mediacard that is being generated. For example, if the mediacard being generated is the 5^{th} mediacard issued to users for a particular mediacard template, entry, or configuration, then the sequence number may include 5, 05, 005, 00005, or any alphanumeric or other graphics that are understood to provide information regarding the number of cards that may be issued. A user identifier 360 may include any identifier for the user and mediacards acquired by an individual are assigned a mediacard unique identifier including the user identifier associated with the user.

As shown in FIG. 3, there are multiple different types of mediacard identifiers available where the format of the unique mediacard identifier is dependent on the type of mediacard. For example, unique mediacard identifiers may include different information depending on whether the mediacard is an unlimited mediacard, limited mediacard, exclusive mediacard, earned mediacard, user-generated mediacard, and/or special edition mediacard.

Unlimited mediacards may include mediacards with no limit on the number of cards that may be issued to users. A unique identifier for an unlimited account identifier may include a source identifier, an authorization identifier, an image identifier, and a sequence number but may not include a user identifier. The unlimited account identifier may not include a user identifier because since the mediacard is not unique or limited to the user, the user may merely store the sequence number and not be concerned about losing access to the mediacard. However, some embodiments of the unique mediacard identifiers may still include the user identifier in order to clearly define the user relationship.

Limited mediacards may include mediacards configured to have a limited number of mediacards issued to users. For example, the mediacards may be valuable (e.g., associated with a coupon, offer, discount, etc.), may be rare or a collection item (e.g., only limited for a short period of time to show who the most committed fans or followers are), and/or may be limited in number for any other suitable reason. For instance, a mediacard that is provided to only those users that log into their reconfigured media provider account while located at a baseball game in order to obtain an exclusive mediacard only offered to those at the event, would be considered a limited type of mediacard.

Exclusive mediacards may include mediacards that are only offered to particular users based on performance or status of the user. For instance, a mediacard that is provided to only those users that log into their reconfigured media provider account while located at a baseball game in order to obtain an exclusive mediacard only offered to those at the event, would be considered an exclusive type of mediacard.

Earned mediacards may include mediacards that require a user action or other performance in order to be obtained. For example, a number of loyalty points or other gamification achievements may unlock or provide an opportunity for a mediacard that is otherwise not available to other users. The format of the mediacard includes similar components as the exclusive and limited mediacards above and are user identifier specific.

User-generated mediacards may include any cards generated by a user and/or determined to be private by the user and thus, not available for issuance to other users at the time being. Unique identifiers associated with user-generated mediacards may not include a source identifier, authorization identifier, or a user identifier because the mediacards are stored in the user profile or associated with the user profile and thus, are not issued to other users yet. The user may share the mediacards but the mediacards may not be issued to other users for future viewing, use, etc.

Special edition mediacards may include similar information to the exclusive, earned, and limited mediacards described above and allows content provides another type of mediacard in order to allow for flexibility and engagement by users for mediacards.

The various identifiers 320-360 may be concatenated or combined in any manner and in any order. For example, a sample mediacard identifier may comprise #SVNBAN13-aa123081100321. Accordingly, the sample identifier may comprise a source identifier (e.g., #SV), an authorized identifier (e.g., NBA), an image identifier (e.g., N13-aa123), a sequence identifier (e.g., 081), and a user identifier (e.g., 100321). Further, any scheme could be implemented to change the order, length, or make-up of the unique mediacard identifiers. Further, a tokenization or encryption scheme may be implemented to protect the unique mediacard identifier from malicious third parties.

6. Video/Links/Content/etc.

Data may be loaded, linked, and presented for a user once a mediacard has been received through any suitable methods. For example, a media input may be provided as part of the mediacard. Alternatively, a mediacard may comprise a link to a media input being stored on a third party system (e.g., content delivery network 170). Accordingly, when the mediacard is interacted with, the user computer 110 may be prompted to send a message to the third party using the link and obtain the media input from the content delivery network 170. The play request message may comprise the unique mediacard identifier that may be used as an authentication credential with the content delivery network 170 and/or the reconfigured media provider 140. Similarly, the text and non-media inputs included in the mediacard may also be embedded into the mediacard or may be linked to a third party or the reconfigured media provider 140.

7. Card Image Sharing/Poster Generation/Copyrighted Image Limited Use License

Cards may be shared between users, posted on common areas where numerous uses can interact with them on social media networks, sent to select partners to be reproduced as posters, shirts, or other merchandise through the social video player application. However, due to the copyright implications of the reproduction and transfer of images owned by third parties (e.g., production companies, sports teams, photographers, AP, etc.), the images associated with the mediacards may be provided a limited implied use license that allows for reproduction of images through designated partners. The limited implied use license or other licensing rights may be associated with the authorization identifier that informs the system where the entity that owns the original rights or the effective use rights of a mediacard. The authorization identifier may be included as part of the unique mediacard identifier. Accordingly, the authentication credential (e.g., unique mediacard identifier) generated by the reconfigured media provider 140 may be used to authenticate that the mediacard is legitimate and the user has the implied rights to regenerate the copyrighted image.

In some embodiments, a user may claim ownership of a mediacard once they've actually captured the mediacard. A user may capture a mediacard and after capturing, the user may have the mediacard stored on their user computer 110 or the mediacard may be stored on a reconfigured media provider 140 and accessed through the reconfigured media provider 140. Once the mediacard is captured, the user computer 110 may open a mediacard application where the user can interact with the mediacards. The user can then view a media input associated with the mediacard or otherwise request services associated with the mediacard. Further, options to share the mediacard or otherwise post a notice of the mediacard to other social media networks may be provided. An actual mediacard may not be shared with a social media network and instead, the image associated with the mediacard may be posted along with a message regarding the user's ownership or other actions associated with a mediacard (e.g., a JPEG image and a message, “User A has obtained a mediacard of Player B.” Accordingly, friends and other users associated with the mediacard may be able to see and interact with a mediacard of a user. If a friend interacts with a shared mediacard, the friend's user computer 110 may be directed to the reconfigured media provider 140 and the friend may be able to view the video associated with the mediacard and/or obtain their own mediacards through the reconfigured media provider 140. Further, the user

Alternatively, in some embodiment, an actual mediacard can also be pushed out to various social networks. Accordingly, a mediacard could be displayed on a Pinterest™ application, on a Facebook™ application, on a Twitter™ application, etc. As such, the mediacards may be formatted in order to fit nicely within each of those respective social networks to encourage awareness, discovery, etc.

### III. Methods of Mediacard Delivery

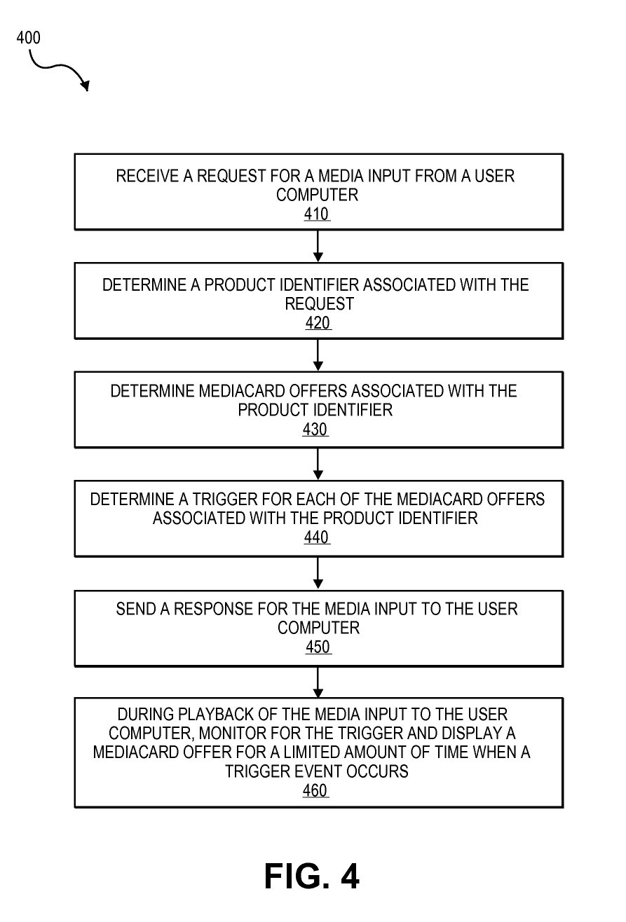

Embodiments of the present invention may deliver mediacard offers or otherwise allow users to request mediacards through a number of different methods and different circumstances. For example, a consumer may publish a mediacard and/or a mediacard story through a publishing tool provided by the reconfigured media provider 140, through posting on one or more social media networks, by setting triggers for automatic publishing of mediacards or mediacard stories, by sending directly to a particular user via email, SMS, etc., or by posting the mediacards on advertising networks or other third party publishers. FIG. 4 shows an exemplary method for delivery of a mediacard to a user, according to one embodiment.

At step 410, a reconfigured media provider 140 may receive a request for a media input from a user computer 110. As described above, the reconfigured media provider 140 may authenticate the user computer 110 and/or user and ensure the user qualifies or otherwise should be provided access to the media input.

At step 420, a reconfigured media provider 140 may determine a product identifier associated with the request. The product identifier may identify a reconfigured media input stored at the reconfigured media provider 140 in a reconfigured media input database and may be associated with media inputs (either stored at the reconfigured media provider 140 or at a third party content delivery network 170) as well as non-media inputs (e.g., chats, engagements, etc.) associated with the media input.

At step 430, a reconfigured media provider 140 may determine mediacard offers associated with the product identifier. A mediacard offer may include a type of engagement stored at the reconfigured media provider 140 that may be triggered at a particular queue time for a media input and may trigger a unique image associated with the mediacard offer to be displayed to a user through a video player operating on the user computer's web browser to view a media input. The mediacard offer may have predetermined limits on the number of cards that may be issued, preconfigured constraints for the type of users or other criteria that users may need in order to obtain the mediacard, or may not be limited in any fashion. Accordingly, depending on the type of card, different conditions may be placed on mediacard offers.

At step 440, a reconfigured media provider 140 may determine a trigger for each of the mediacard offers associated with the product identifier. A trigger may include any possible trigger variable provided through the video player providing the media input. For example, the trigger may be a trigger time, a manual input by a moderator, announcer, or other third party, or may include a certain word or statement being stated by the media input. Additional triggers may include activity-based triggers, location based triggers, performance triggers, video annotation triggers, and any other relevant triggers as describe above in reference to mediacard generation.

At step 450, a reconfigured media provider 140 may send a response for the media input to the user computer 110. The response for the media input may include a reconfigured media input including both non-media inputs (which may include the mediacard offers as well as other engagement data) and a media input or a link to a media input. More information regarding user interactions, engagements, and delivery of reconfigured media providers may be found in U.S. patent application Ser. No. 14/475,369, filed Sep. 2, 2014, which is hereby incorporated by reference in its entirety for all purposes.

At step 460, the user computer 110 may monitor during playback of the media input a time of the playback and an associated trigger and display a mediacard offer at the trigger. The mediacard offer may only be displayed to the user for a limited time.

A. Mediacard Generation Based on Performance

Mediacards may be generated based on the performance of a particular player, movie, character, or organization on a given date. For example, a baseball mediacard may be generated for a player when they hit more than 1 home run in a game. As another example, a mediacard may be issued for a movie when the movie obtains high ratings (e.g., two thumbs up), record box office results, an actor in the movie wins an Oscar, etc. Celebrities may also select and/or issue personalized mediacard editions.

This is advantageous because the gamification aspects of the user experience are enhanced as users may be able to maintain interest in events watching for performance that will result in new mediacards, points, etc. and users may choose events to follow based on perceived value or potential performance.

The reconfigured media provider 140 may implement any number of methods for determination of performance events that are worthy of generating mediacards. Further, the generation of mediacards based on performance may be implemented through both automatic and/or manual processes. For example, an algorithm may be used to scour box scores and stat lines of games provided by third party systems or stored at the reconfigured media provider 140 and determine those players that may have had a particularly noteworthy performance. Accordingly, images may be pulled and identified from the event that are associated with the character, team, entity, or other subject matter relevant to the performance and a mediacard offer may be generated with the character's or player's performance stats, career stats, etc. As such, mediacard offers may be generated automatically in some embodiments using performance metrics to determine when a mediacard may be generated. Alternatively, mediacard offers may be generated by system administrators, celebrities, news services, etc. that may select plays of the week, particularly impressive seasons or performances, etc.

B. SocialVideo Player Based Mediacard Delivery

Cards may be generated within a reconfigured media providers' social video player application 500 when a user interacts with a dynamic mediacard display engagement region on the social video player application 500.

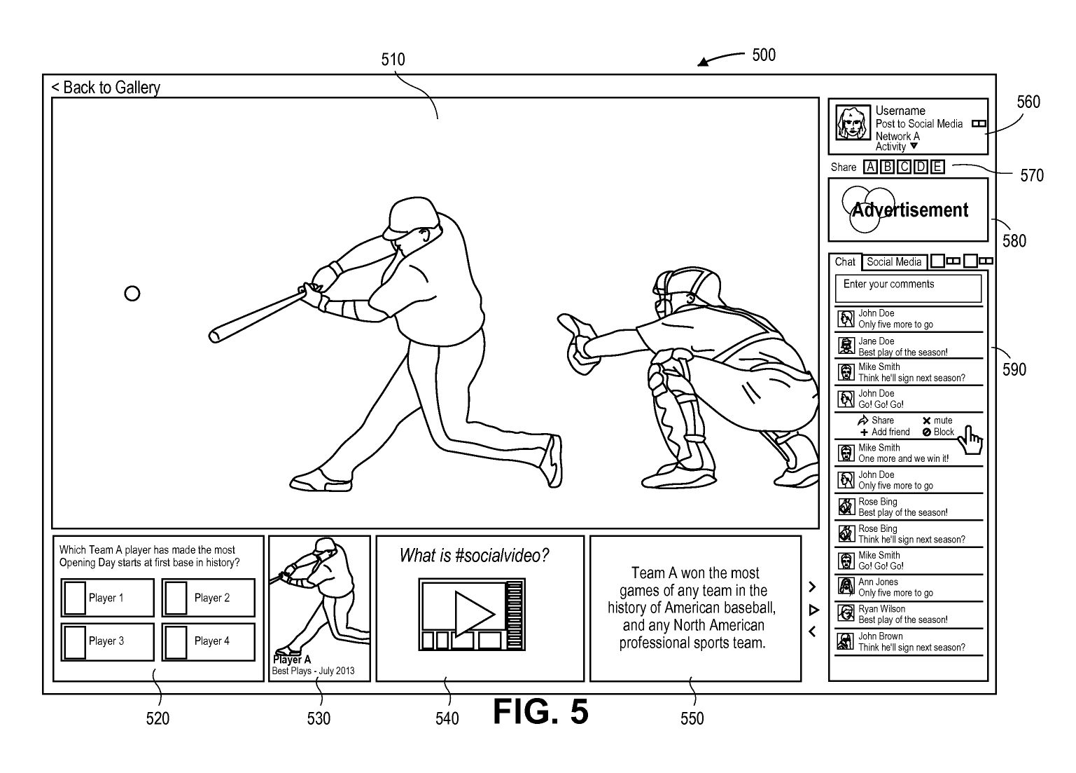

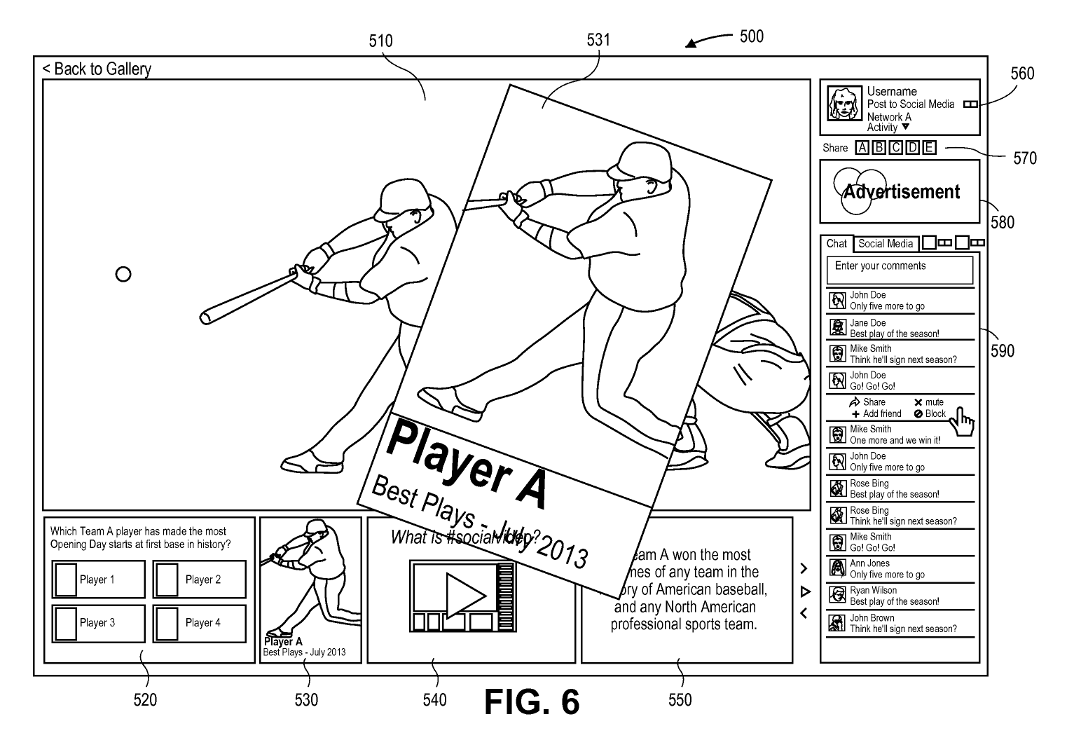

FIGS. 5 and 6 show an exemplary graphical user interface for providing a mediacard offer and issuing a mediacard through a social video application 500 delivered by the reconfigured media provider 140. The reconfigured media provider's social video application 500 is an application (either native to a mobile device or accessible through a web browser operating on a computer) that may be delivered by a reconfigured media provider 140 to a user computer 110 in a reconfigured media input request message. Accordingly, a browser or other program operating on a user computer 110 may be provided with a video player that is capable of playing a media input that may originally be provided by a content delivery network 170 (e.g., Yahoo™, YouTube™, etc.) using a wide-variety of video formats and video players. The media input may be surrounded with non-media inputs (e.g., social engagements and interactions) 520-590. For example, chat messages 590 may be provided on the right side of a video player 500 outside of the media input 510 or messages 590 from social media networks may be displayed instead of chat messages (e.g., Twitter™ or a Facebook™ wall post area may also be provided so the user can comment about the media input being experienced). Furthermore, along the bottom of the video player there may be annotated visuals 520, 540 related to the content being provided by the media input 510.

As such, annotated videos 540 including, for example, a ‘what is social video’ engagement 540, may be provided for a user to interact with and obtain additional. The user may then click on the engagement 540 and may receive a synopsis of what the engagement 540 is that further describe how the user should interact with the application 500 or media input 510. Therefore, as the media input 510 is playing, the engagement areas 520-590 may change in terms of the queue points of engagements and engagement data stored at the reconfigured media provider 140 (and delivered to the user computer 110).

Accordingly, one of the engagement areas provided by the video player includes a mediacard offer area 530. FIGS. 5 and 6 show this area as the graphic of a mediacard showing a player 530. The user may click on the mediacard engagement area 530 when the mediacard offer is triggered (thus showing a new mediacard). FIG. 6 shows the mediacard offer 530 after a user clicks on the mediacard offer and a graphic 531 indicating that the mediacard is issued to the user in response to the user sending a mediacard request to the reconfigured media provider 140 is shown. The reconfigured media provider 140 may determine if the user qualifies and otherwise should have the mediacard issued on their behalf. If so, the reconfigured media provider 140 may generate the unique mediacard identifier and the user may have the mediacard sent to their user computer 110 as well as have the mediacard stored on the mediacard database at the reconfigured media provider 140.

Therefore, mediacard information associated with mediacard offers may be pre-configured and loaded into the social video player 500 to be triggered at relevant times during a live event or on-demand playback of a media input 510 and unique mediacards may be generated when a user interacts with the digital mediacard engagement region 530 at the appropriate time depending on the type of event and mediacard offer. This is advantageous because users engagement with the event will be enhanced if new mediacards appear and disappear regularly such that a user must stay engaged with the content in order to receive mediacards that are scarce, desirable, valuable, and/or otherwise beneficial or appealing to the user.

C. Live Event Based Mediacard Generation

For live events, mediacard data may be pre-configured prior to the live event based on a rough organization of the event (e.g., track list of a concert performance, batting lineup, etc.) and may be triggered by a moderator for the live event.

Alternatively or additionally, during a live event, the reconfigured media provider 140 may know certain cue point based on a track list or other information and may have some pre-generated information available regarding the media inputs and may insert a mediacard offer at that time.

Additionally, a moderator or other third party may be in charge of triggering offers for a particular media event and may trigger a mediacard offer with a manual input.

1. Limited Edition

In order to incentivize attendance and participation during live events, limited edition mediacards may be generated during live events that are limited in number and may only be provided to a limited number of users based on the speed with which they request the mediacard (e.g., only the first 100 users to click on the generated mediacard may own the mediacard). Further, the mediacards may only be provided during live events and may not be included in the on-demand version of the event that may be viewed at some later time.

2. High Point Value

Additionally, mediacards that are generated during live events may be provided with higher point values than on-demand viewings since the mediacards are limited and the purpose is to drive attendance at the live event.

D. On-Demand Based Mediacard Generation

For on-demand playback events that may be viewed at any time by users, mediacards may still be queued up and provided at designated times based on timing queue points in the on-demand video.

1. Widely Available

In order to incentivize playback of on-demand events, mediacards that are provided may be more widely available such that there are larger numbers of mediacards provided (e.g., up to 10,000 mediacards may be issued for each mediacard or the number may be unlimited).

2. Special Edition First Viewing Mediacards

However, on-demand events may also implement live event like limited mediacard generation such that the first time the on-demand video is shown or for the first day that an on-demand video is posted, special mediacards can be available that may not be available on subsequent viewings. Accordingly, multiple versions of on-demand viewings may be possible.

3. Lower Point Value

Further, because viewership may not be as important to the sponsor and in order to maintain an incentive for live viewing, on-demand mediacards may be provided lower point values than live event mediacards.

E. Location Based Mediacard Deliver

Alternatively, some mediacards (e.g., limited edition mediacards) may be issued to a user that is physically present at an event (e.g., the mediacard of a pitcher that pitches a no-hitter may be provided to all registered users that are in attendance at the game). The mediacards may be limited such that only mediacards are issued to the limited number of registered users in attendance at the event. This is advantageous because it provides users with an incentive to engage with the subject matter or entity associated with the event online to further their in person experience. It also incentivizes users to attend marketed events in person.

Accordingly, a mediacard may be issued to only those users that attended an event. Therefore, event-based mediacards may be generated and sent to users during or after an event. The reconfigured media provider 140 may implement a process of determining that the user is present by determining an event location associated with the product identifier, determining a location of the user computer 110, comparing the location of the user computer 110 to the event location to determine if the user is present at the event location, and if the user is present at the event location, determining mediacard offers associated with the product identifier including location-based mediacard offers. As such, users present at events may be presented with a different set of mediacard offers than users who are not present at an event. The mediacard offers may be provided to a user computer 110 at the time that a reconfigured media input is sent to the user, while their at an event, or the event based mediacard offers may be provided at a later time.

1. Methods for Determining Attendance/Card Issuance

The location of the user may be determined through any suitable manner including the location of a registered device associated with the user (e.g., a mobile device that is used to access the reconfigured media provider 140) using GPS or other location-aware hardware and software processes (e.g., location-based services approaches).

a) Automatic Generation Based on GPS Location

Cards may be issued to all registered users that have installed a mobile application in their phone, tablet, etc. that indicates they are present at the event based on GPS or other location based information from their mobile device.

b) Mobile Application Distribution

Alternatively, a user may log into their social video player account and request a mediacard while they are in attendance at an event. Accordingly, users may engage with content surrounding an event through the social video player application while also experiencing the event in-person.

c) Sponsorship Opportunities

Additionally, in some embodiments, sponsors or partners may set up events surrounding product launches, marketing events, etc. and users may be provided unique or limited mediacard opportunities if they visit sponsors websites, sales events, etc. Accordingly, a user may attend a promotional event and while at the event and access the mediacard application or the reconfigured media provider 140.

### IV. Mediacard Trading Exchange and Point Marketplace

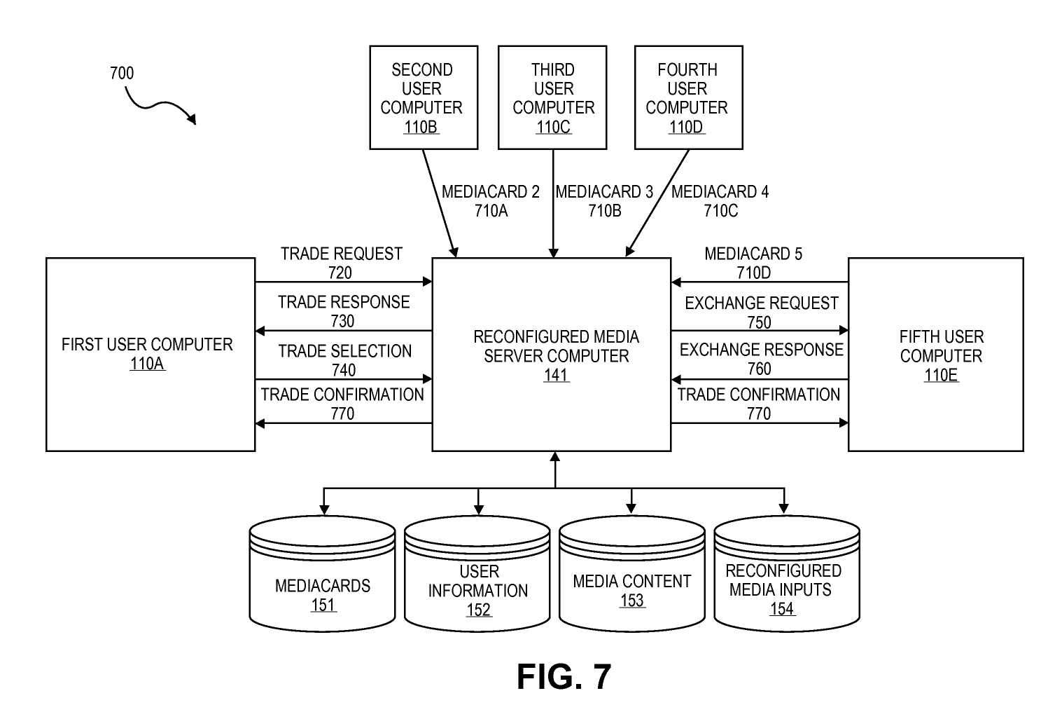

FIG. 7 shows an exemplary flowchart showing a mediacard trading exchange and point marketplace engaging in an exemplary method of trading a mediacard on the trading exchange, according to an exemplary embodiment. The trading exchange and point marketplace may have numerous other elements or may comprise fewer elements than those shown in FIG. 7 and may be operated by a third party outside of the reconfigured media server computer 141.

At steps 710A-710D, a plurality of users operating a plurality of user computers 110B-110E (e.g., second user computer 110B through fifth user computer 110E) submit or otherwise provide their mediacard information to the trading exchange. For example, the plurality of users may submit trade requests that include unique mediacard identifiers and the reconfigured media provider 140 may generate trade offers that may be stored on a trading database. Accordingly, users may provide trade details (e.g., requested value, interested subject matter, terms, etc.) associated with the trade request that may be used in identifying and validating relevant trade requests and potential matches for trades between mediacards.

At step 720, the first user computer 110A generates a trade request that includes a unique mediacard identifier associated with an image identifier. The reconfigured media provider 140 authenticates and/or validates that the received mediacard is associated with the user identifier (e.g., owned) associated with the received trade request and that the mediacard was issued for the associated image identifier. For example, the reconfigured media provider 140 may parse the unique mediacard identifier to obtain the image identifier and search the mediacards database for a mediacard associated with the image identifier (or other unique identifiable information). The reconfigured media provider 140 may then validate whether the mediacard entry in the mediacard database includes the user identifier as being a user that has been issued one of the mediacards, whether the unique mediacard identifier identifies an authentic issued mediacard, and whether the mediacard belongs to another user or was fraudulently generated or stolen. Accordingly, the reconfigured media provider 140 may determine the authenticity of the trade request before moving forward with any trade actions.

The reconfigured media provider 140 may determine a value for the mediacard dependent on performance of a subject matter or entity associated with the mediacard, a total number of issued mediacards associated with the image identifier, and an interest level associated with the mediacard. The reconfigured media provider computer may search a database for mediacards associated with other users having an equal or lesser value than the user's mediacard. Accordingly, the reconfigured media provider 140 may obtain or identify other users' mediacards that are of similar value and may be candidates for a trade. Furthermore, during registration or during a trade request, the user may provide trading profile information or other trading options that may allow the reconfigured media provider computer to filter or better match mediacards to a user's interests (e.g., based on subject matter, value thresholds, etc.), types of interested trades (e.g., multiple cards for 1 card trades, multiple user trades, etc.), or any other relevant parameters associated with mediacard trading or values.

At step 730, the reconfigured media provider 140 may send the mediacards associated with other users to the user computer in a trade response. The trade response may include any information about the mediacards including the type of mediacard, the image associated with the mediacard, a product or reconfigured media input associated with the mediacard, past transaction history associated with the trading card, value of the trading card, user information, etc.

At step 740, the reconfigured media provider 140 may receive a selection of at least one of the mediacards associated with the other users. The user may select a mediacard provided in the trade response for a potential trade by providing an input through the user computer after the consumer performs any actions related to the available mediacards and makes a trade decision. For example, the user may review the available mediacards included in the trade response, provide counter offers (e.g., combine available mediacards to increase the value of the mediacard trade), and ask any questions to the other users associated with the available mediacards provided in the mediacard trade response. The user may perform any other relevant steps prior to deciding on a mediacard to select from the trade response.

At step 750, the reconfigured media provider 140 may generate an exchange request and send the exchange request to the owner of the at least one selected mediacards. The exchange request may include mediacard information (e.g., images, image identifiers, configuration parameters, type of mediacards, product identifiers associated with the mediacards, etc.) associated with a trade that allows an owner of the selected mediacard to determine whether the terms of a trade. For example, the exchange request may include information associated with the user selected mediacard from the trade response and the originally identified mediacard provided in the trade request. Accordingly, the exchange request may include any information relevant to a mediacard owner (e.g., user, corporation, marketing agency, etc.) associated with a mediacard to determine whether a proposed trade of mediacards or exchange of a mediacard for value or other exchanges is acceptable. Additionally or alternatively, the exchange request may include the terms of the mediacard trade as determined and/or provided by the reconfigured media provider 140, the user through the trade request or negotiation with the system or other users, and/or any other entity trading configurations, contracts, etc.

At step 760, the reconfigured media provider 140 receives an exchange response from the owner. If the owner agrees to the exchange, the reconfigured media provider 140 may generate replacement unique mediacard identifiers for the mediacard and the at least one selected mediacard where the user identifier's for each mediacard is exchanged. In this manner, the unique identifiers for the respective mediacards are not lost and are merely associated with a new user identifier. Additionally, this maintains the limited and scarce nature of the mediacards, as new mediacards are not issued for the trades. In some embodiments, new identifiers may be issued for each user and the old unique identifiers may be deleted, revoked, and/or restricted.

At step 770, the reconfigured media provider 140 may send the updated mediacards to the user and the owner in a trade confirmation. The trade confirmation may further include confirmation of the trade details including the value exchanged, account information for those exchanges that include any interaction with financial accounts, loyalty accounts, or any other accounts associated with the users. In some embodiments, the trade confirmation may merely notify the users that the trade has been completed and to report the updated mediacard identifiers. In other embodiments, each party may obtain a customized trade confirmation that provides secure or sensitive information that may be relevant to each user regarding the trade (e.g., an account balance, purchase information, account information, etc.). Any information associated with the trade may be provided in the trade confirmation. Additionally, the reconfigured media provider 140 may update the respective mediacards stored in the mediacards database as well as the respective user profiles to indicate the traded status of the mediacards (e.g., the traded mediacard may be removed from a user's collection of mediacards and replaced with the traded mediacard in the user's profile). Accordingly, after receiving the trade confirmation, each user now use, share, and/or trade the mediacards as they wish.

A. Interactive Trading Marketplace Based on Mediacard Point Values

The digital trading mediacard platform may also provide an interactive marketplace for trading mediacards between users and organizations/sponsors. This is advantageous because it provides the foundation for all of the rewards and generates a new way for users to interact with the subject matter or entity associated with digital mediacards. It also provides a competitive venue to further engage with friends and drive new users.

B. Card Values Dependent on Performance

Each trading mediacard may have some value or points based on how rare, important, or interesting the mediacard is. For example, a mediacard issued because a player threw a perfect game may be worth 500 points while a mediacard for a player hitting a home run during a game may be worth 50 points.

The value of the mediacards may be measured in monetary value, reward points, experience points, or any other suitable method of providing value to a digital object. For example, if the value is measured in reward points, the reward points of mediacards may be traded to get a different mediacard the user would prefer. For instance, if a user has a collection of five mediacards and the user wants to trade those mediacards in for a more desirable, rare, or valuable mediacard, the user may trade in one or more of their collection of mediacards in order to obtain the single more valuable mediacard.

1. Dynamic Mediacard Value

The value of each mediacard may be dynamic such that some mediacards may lose value over time (e.g., if the subject matter or entity of the mediacard is toxic, negative, or falls out of favor with sponsors or users) and others may gain in value over time (e.g., if a player is voted as an all-star, a mediacard for that player may gain a certain % of points).

A particular mediacard may be just a regular game that this mediacard was produced from for that particular week, so it may have a value of a hundred points. However, if a player happened to hit for the cycle that day, that mediacard may now be worth five hundred points, or a thousand points, or whatever the case may be. And so the value of the mediacards may change based on the relative value of that player or how he performed in the particular game where the unique image was captured from. Accordingly, unlike traditional baseball mediacards, which may have a stable value set at the beginning of the year, the mediacards can be much more current and frequently produced.

Further, a mediacard may have predetermined expiration date and may only be active for a small period of time.

C. Exchange Opportunities

Some mediacards may be exchangeable or tradable between users using the mediacard marketplace. Accordingly, users may exchange favorite highlights, players, etc. and may exchange points in trades as well.

D. Personal Mediacard Collections

FIG. 8 shows an exemplary collection of mediacards that may be received, stored, exchanged, and collected by a user. Accordingly, users may use the mediacards to generate their own personal mediacard collections (e.g., My All Time Best Third Basemen, an All-star team for the year, five best bands of 2013, etc.). For instance, the user may start creating a collection of mediacards of their favorite third base players. Therefore, users may be able to generate collections and lists of their top movies, characters, musicians, bands, etc. The users may create these collections of mediacards, and then share the collection on social media networks with their friends. Additionally, users may be able to search their friends collections or content providers collections.

FIG. 8 shows a content providers collection of mediacards (e.g., “media network A's baseball plays of the week”). As can be seen in FIG. 8, the collection display associated with a user, content provider, advertiser, etc., may be browsed by a user 860 logged into the reconfigured media provider system. The collection page may show a number of different mediacards with different images for each mediacard 820A-820J (or mediacard stories). The user 860 may browse the available mediacards, select a mediacard in order to launch additional information about the mediacard (e.g., the mediacard flipping over to display a media input and non-media inputs associated with the mediacard), and may select a mediacard to be issued to the user and stored in the user profile. Additionally, the user may browse other collections associated with the media content provider 160 by using a search function or browse other collections associated with the current collection button 821.

E. Gamification Capabilities

Embodiments of the present invention may further implement Gamification capabilities that incentivize the collection and exchange of mediacards through the reconfigured media provider 140. In some embodiments, application functionality may be separated into different membership levels and games surrounding the mediacards may be provided. For example, all users may be provided with a single mediacard collection but premium members may be provided with additional personal collections, user generated cards may be allowed where users may select and generate their own mediacard offers for friends or other users, and premium mediacards may be provided to premium members. Additionally, further distribution or licensed uses may be provided to premium users (e.g., mediacards may be issued to multiple devices, shared through different distribution channels (e.g., email) and other functionality may be provided.

1. Points Redeemable for Discounts/Merchandise/Etc.

Additionally, in some embodiments, mediacard points may be exchanged for other mediacards or for discounts, coupons, free products, services, etc. For example, the rewards points associated with mediacards may be related to coupons, discounts, sales, or other advertisements. For instance, a thousand points worth of mediacards may be traded in to obtain twenty percent off some related merchandise. Furthermore, the points could also be provided independent of the mediacards themselves and the mediacards may not have to be redeemed or traded in order to obtain the value (e.g., the user gets 1000 points for the mediacards and may be able to trade the points for merchandise without losing the mediacards).

F. Fantasy Game Platform

Digital mediacards may also be implemented into fantasy games such that players may select players, characters, movies, etc. and play games based on collections of such mediacards that will be the most valuable, influential, and/or successful by the end of the year. Further, points may be provided on a weekly basis depending on the mediacards a user has possession of and games may be configured surrounding the value of such mediacards.

### V. Methods of Mediacard Display

Mediacards may be displayed through any suitable manner according to embodiments of the present invention. Mediacards may be viewed or interacted with to view the underlying performance, play, or important events related to the mediacard by the user. The mediacards may be configured such that they fill the full screen of any type of user computer (e.g., mobile device, tablet, etc.) and different mediacard files may be provided to a user account that may be displayed depending on the device being used to view the mediacard (e.g., display screen size and resolution, etc.).

A. Swipe and Flip Viewing Experience

When a user wishes to review their mediacards, a user may swipe through their database of mediacards until they find the mediacard they wish to view, they may select the mediacard by pressing on the display, and a video of the event, play, famous scene, interview, etc. may be played by the mediacard. After the user touches the screen face, the mediacard may flip over, and a video may be viewed on the back side of the mediacard. This is advantageous because it mimics the user experience of trading mediacards and reinforces the interactive experience of the digital trading mediacard platform.

Additionally, it allows for users to move through a large number of items (e.g., mediacards) quickly and easily without the system launching and downloading large amounts of information for each mediacard. For instance, once a user interacts with a mediacard and the mediacard flips for viewing of detailed information, the media input, and the non-media input, the device may handshake with a content delivery network 170 and start downloading or buffering the media input for display or playback.

For example, a user may flip through a number of mediacards and the flipping may occur in a very seamless fashion. When a user sees the mediacard they want to watch, the user may double click (or single click, select, or otherwise interact) with the mediacard. The mediacard may flip over in a visual animation including a transition that may be configured in the mediacard parameters by a user generating the mediacard and the user can click on a media input (e.g., video playback button) and watch the media input (e.g., a highlighted baseball play).

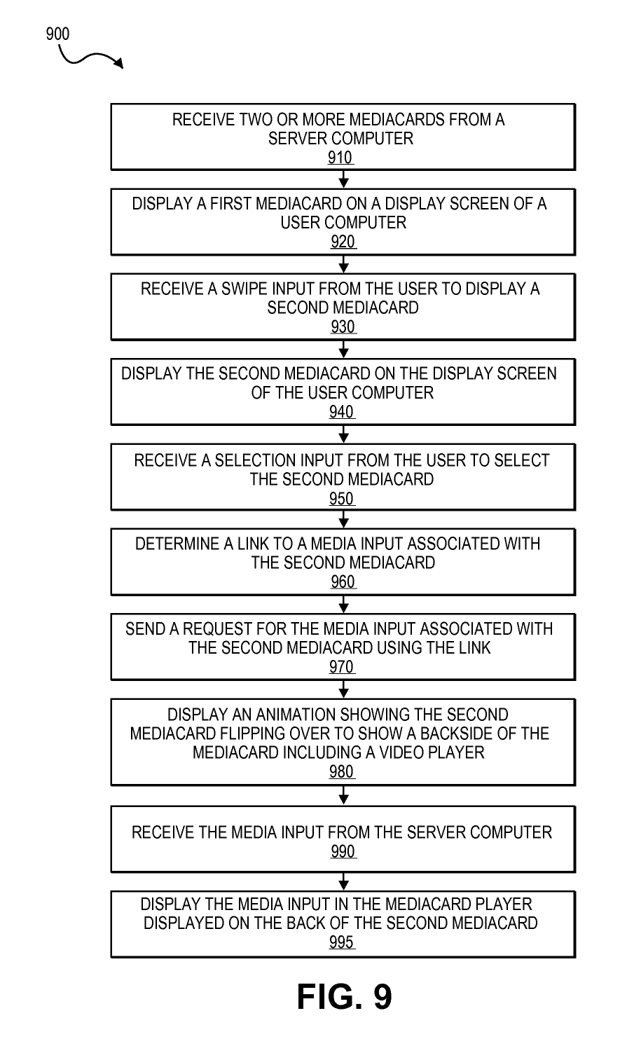

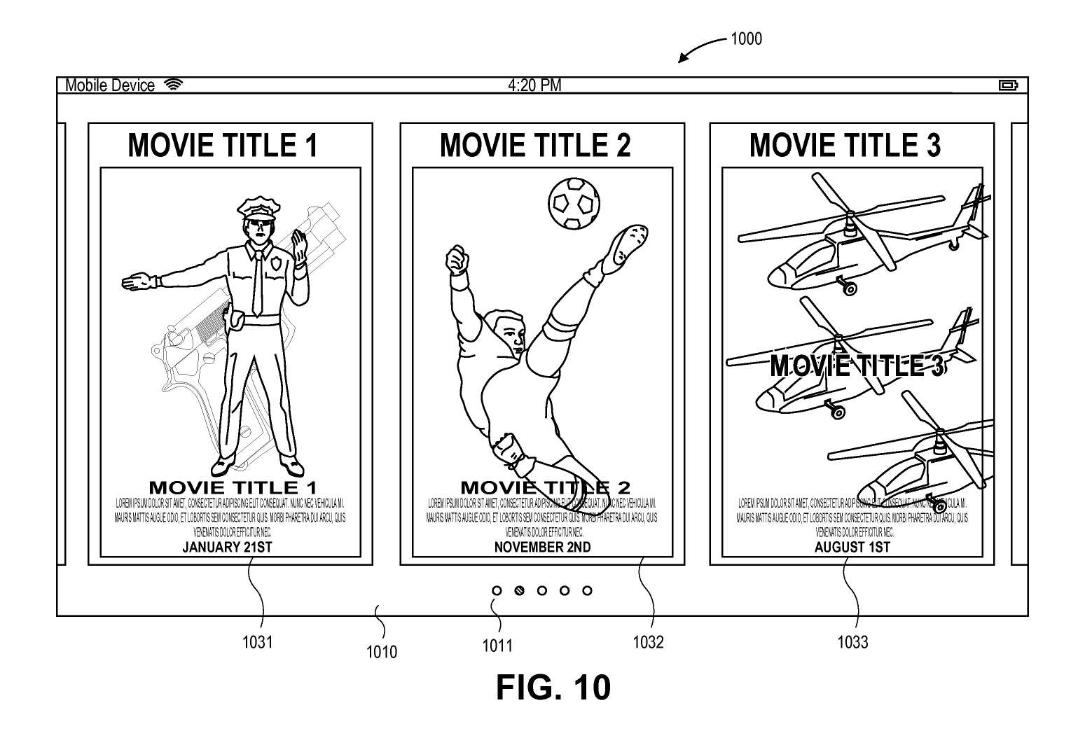

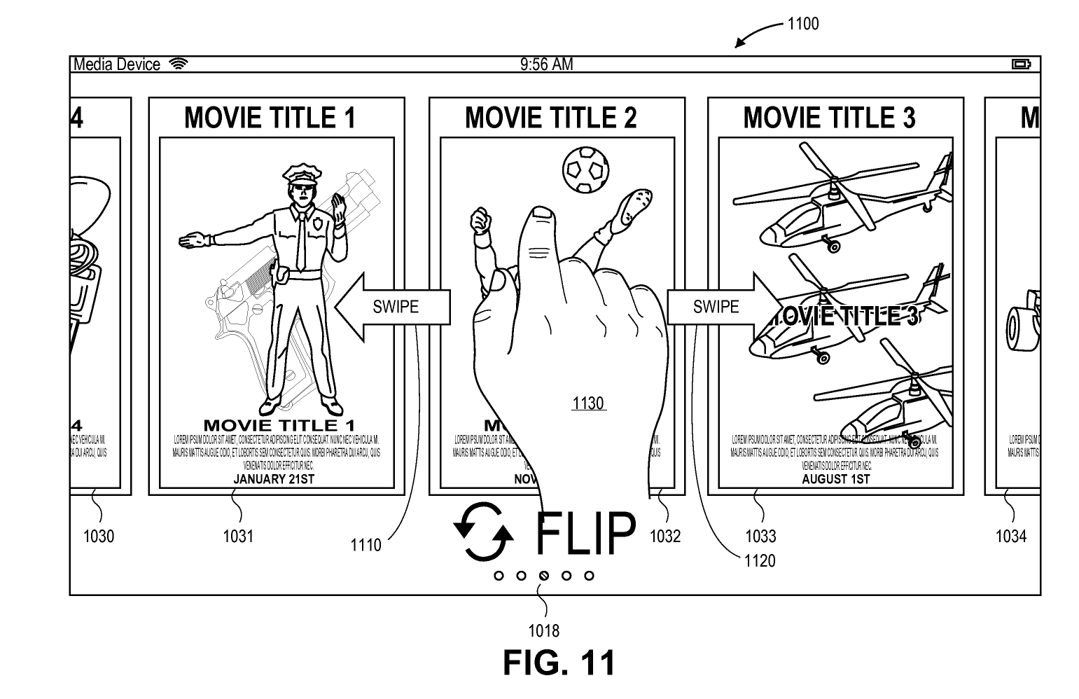

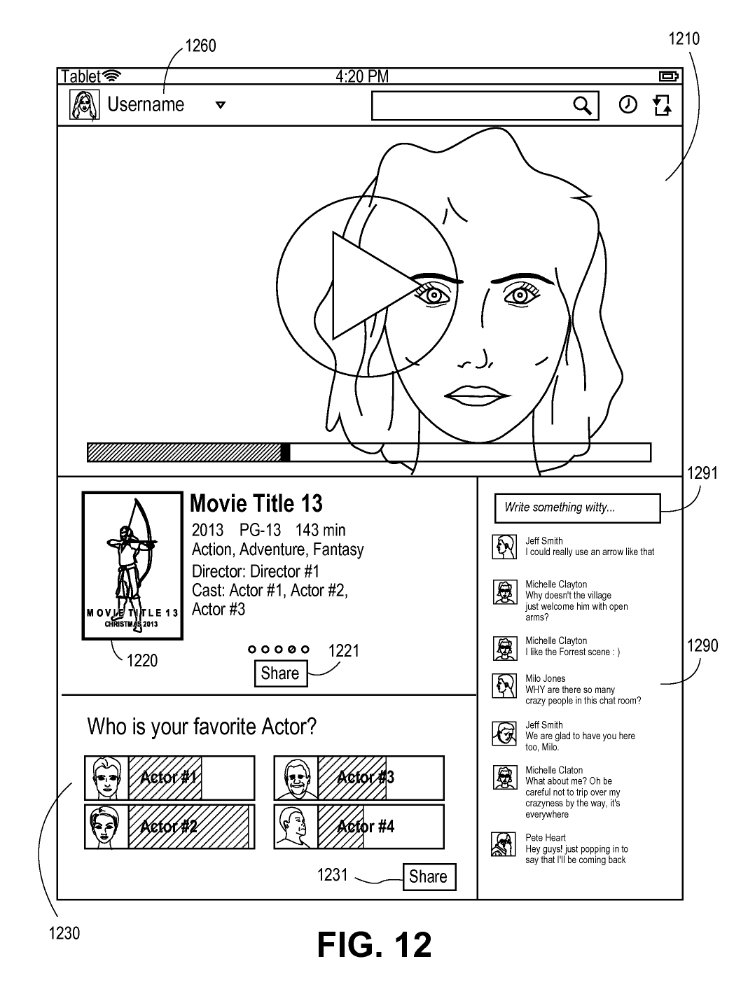

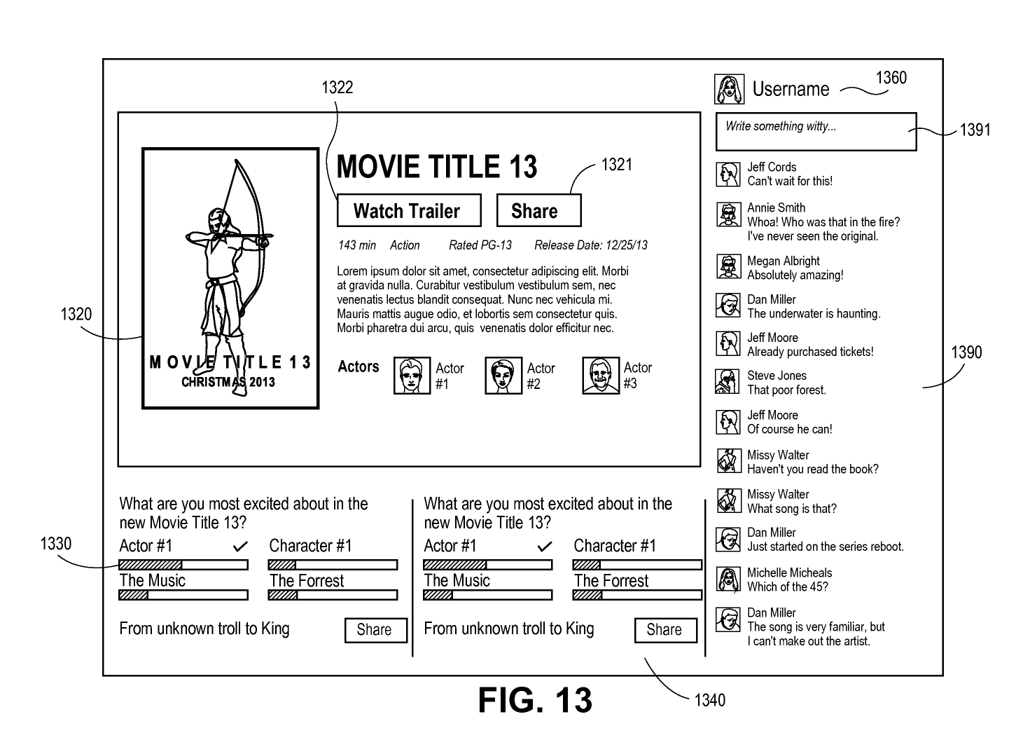

FIG. 9 shows an exemplary method of displaying mediacards on a user computer, according to one embodiment. FIGS. 10-11 show a series of screenshots of a display of a user computer as a user swipes through the mediacards and FIGS. 12-13 show various screenshots of the display of a user computer including the backside of various mediacards after a user has interacted with a specific mediacard. The provided screenshots show only examples of such layouts and the text, images, and presentation areas of the exemplary screenshots may be moved, modified, altered, combined, and otherwise moved into a number of different configurations. Accordingly, the text and substance of the screenshots are illustrative only and any subject matter or other images and information may be provided. As such, the various elements of the depicted designs are not limited to the placement on the screen as shown in the exemplary screenshots.

Returning to FIG. 9, at step 910, a user computer receives two or more mediacards from a server computer. The mediacards may be selected by the user or provided to the user by the reconfigured media provider 140 through any suitable filtering, selection, or providing steps. For example, the user may be viewing their personal library of mediacards that have already been issued to the user. Alternatively or additionally, the user computer may receive mediacards associated with a particular subject that the user may have searched for or otherwise indicated interest in. Additionally, the user computer may have entered a particular location (e.g., a movie theatre) and a series of mediacards are provided to the consumer device (i.e., user computer) based on the location of the consumer. The two or more mediacards may include an image, a link to a media input associated with the mediacards, non-media inputs (e.g., chat messages, engagements, etc.), a unique mediacard identifier for those mediacards that have been issued to the user, and any other relevant information to the user. In some embodiments, much of the mediacard information may not be loaded by the user computer until a user interacts with the mediacard to ensure fast viewing of many mediacards (e.g., a handshake with a content delivery network 170 may not be performed and non-media inputs may not be provided with the initial mediacard until a user interacts with a particular mediacard).

At step 920, the user computer displays a first mediacard on a display screen of a user computer. An image associated with an image identifier and a title may be displayed on the display screen. As shown in FIGS. 10-11, the various mediacards 1031-1033 may each have a different image that is displayed in the format of a playing card, media poster, or other rectangular appearing media content. In this manner, it is easy to view multiple options for playback or selection quickly and easily. Furthermore, the images are large enough for a user to view details regarding each mediacard (e.g., a movie title, details, release date, subject matter of the mediacard, etc.) to further inform the user before they interact with the mediacard.

At step 930, the user computer receives a swipe input from the user to display a second mediacard. As shown in FIG. 11, the swipe motions may be provided by a cursor or a user's finger 1120 or any other suitable input. The swipe may include multiple levels of force to speed up the shifting of mediacards or may be slower to slow down the shifting of media cards. When swiping the mediacards, the images may pass quickly in front a user but the large image and information provided to the user may allow a user to intuitively and easily stop the swiping motion by contacting the display or providing a user input to stop the motion. Accordingly, the consumer may browse a large number of mediacards including a large amount of information in a short period of time and not miss interesting mediacards to a user.

At step 940, the user computer displays a second mediacard on the display screen of the user computer. As the swipe input is provided by the user, a plurality of media cards may be displayed by the user computer in order of the mediacards as received by the reconfigured media provider 140.

At step 950, the user computer receives a selection input from the user to select the second mediacard. At some point, a user may see a mediacard that they are interested in learning more information about as the plurality of mediacards are swiping across their screen. Accordingly, the user may press the screen, swipe the opposite way on the screen, or otherwise interact with the screen in order to select a particular mediacard image.

At step 960, the user computer determines a link to a media input associated with the second mediacard. Once a mediacard is selected, the user computer may use the link to the content delivery network 170 to load the media input and complete a security handshake (if not already performed) with the content delivery network server computer associated with the media input. Accordingly, the user computer determines the link to the media input included in the mediacard and generates a request for a media input associated with the link.

At step 970, the user computer sends a request for the media input associated with the second mediacard using the link determined by the user computer. The server computer may be the same server computer as previously provided the two or more mediacards or may be a third party (e.g., content delivery network server computer) that stores the relevant media input. Any authentication information, security validation information, profile information, and any other relevant information may be provided in the media input request in order to ensure the content delivery network 170 that the consumer may be provided access to the media input associated with the link.

At step 980, the user computer displays an animation showing the second mediacard flipping over to show a backside of the mediacard including a video player. For example, as shown in FIG. 11, a user may interact with the mediacard by pressing on the image, and the card may flip as shown by the movement indicator 1018. The backside of the mediacard may comprise a second image associated with an image identifier, the same image, a wide variety of non-media inputs (e.g., engagements, chats, stats, etc.) and any other relevant information on the display screen. For example, the backside of a different mediacard than that shown in FIG. 11 is shown in FIGS. 12 and 13. As can be seen in FIGS. 12 and 13, the backside of the mediacard includes a playback area for the media input 1210, an image 1220, integrated sharing functionality 1221, engagements (e.g., a poll) 1230, and chat messages 1290 provided by other users associated with the media input. Accordingly, the backside of the mediacard may include a mediacard player button which initiates playback of the media input 1210 once it is received from the content delivery network server computer. Alternatively or additionally, the media input may be stored on the user computer due to a mediacard having the media input embedded into the mediacard and the media input may begin playing as soon as the card is flipped to the backside. FIG. 13 shows another view of the backside of a mediacard with a different type of layout but similar functionality and interaction capabilities provided.

At step 990, the user computer receives the media input from the server computer. Depending on the configuration of the mediacard, the media input may start playback or may wait for a user input before playback is initiated.

At step 995, the user computer displays the media input in the mediacard player displayed on the backside of the second mediacard. Accordingly, the user can browse through a large number of mediacards in a quick and easy manner, select a mediacard that interests the user, and be provided with media inputs associated with the mediacard in a seamless and intuitive manner. Although the examples provided include video cards (i.e., video type of media inputs), any other type of media may be provided as described above.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it may be understood that combinations, additions, re-arrangements, and the like are contemplated in alternative embodiments of the present invention. Thus, while the invention has been described with respect to example of embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

### VI. Computer System

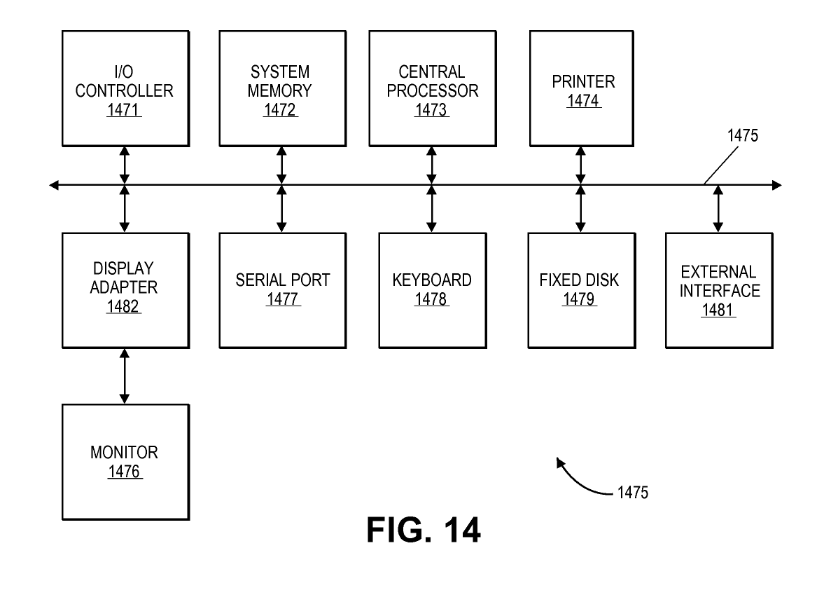

FIG. 14 shows a block diagram of an example computer system 1400 usable with system and methods according to embodiments of the present invention.

Any of the computer systems mentioned herein may utilize any suitable number of subsystems. Examples of such subsystems are shown in FIG. 14 in computer apparatus 1400. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 14 are interconnected via a system bus 1475. Additional subsystems such as a printer 1474, keyboard 1478, storage device(s) 1479, monitor 1476, which is coupled to display adapter 1482, and others are shown. Peripherals and input/output (I/O) devices, which couple to I/O controller 1471, can be connected to the computer system by any number of means known in the art, such as serial port 1477. For example, serial port 1477 or external interface 1481 (e.g., Ethernet, Wi-Fi, etc.) can be used to connect computer system 1400 to a wide area network such as the Internet, a mouse input device, or a scanner. The interconnection via system bus 1475 allows the central processor 1473 to communicate with each subsystem and to control the execution of instructions from system memory 1472 or the storage device(s) 1479 (e.g., a fixed disk, such as a hard drive or optical disk), as well as the exchange of information between subsystems. The system memory 1472 and/or the storage device(s) 1479 may embody a computer readable medium. Any of the data mentioned herein can be output from one component to another component and can be output to the user.

A computer system can include a plurality of the same components or subsystems, e.g., connected together by external interface 1481 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A method for issuing a mediacard to a user, the method comprising:
receiving a request for a mediacard from a user computer, wherein the request includes an image identifier and a user identifier;
determining, by a server computer, a type of mediacard associated with the image identifier;
identifying, by the server computer, a user profile of the user associated with the user identifier;
analyzing, by the server computer, the user profile to determine if the user qualifies for the mediacard associated with the image identifier;
if the user qualifies for the mediacard, generating a unique mediacard identifier for a first mediacard, wherein contents of the unique mediacard identifier depend on the type of mediacard associated with the image identifier, and wherein the unique mediacard identifier includes at least the image identifier and a unique sequence identifier, the unique sequence identifier identifying the first mediacard from other mediacards associated with the image identifier;
determining, by the server computer, media content associated with the first mediacard; and
sending, by the server computer, a response including the first mediacard to the user computer, wherein the mediacard includes the unique mediacard identifier and the media content.

2. The method of claim 1, wherein the unique mediacard identifier further comprises at least one of a source identifier, an authorization identifier, and the user identifier depending on the type of mediacard associated with the image identifier.

3. The method of claim 1, wherein the media content includes a link to a media input and non-media inputs associated with the media input.

4. The method of claim 3, wherein the method further comprises:
storing the unique mediacard identifier as an access credential for the link to the media input.

5. A method for delivery of a mediacard to a user, the method comprising:
sending, by a user computer, a request for a media input provided by a reconfigured media provider;
receiving, by a user computer, a reconfigured media input from a server computer associated with the reconfigured media provider, the reconfigured media input comprising mediacard offers associated with the media input and a link to the media input associated with a content delivery network computer, wherein the reconfigured media provider identifies the mediacard offers associated with the media input and determines a trigger for each of the mediacard offers;
sending, by the user computer, a request for the media input to the content delivery network computer;
receiving, by the user computer, the media input from the content delivery network; and
displaying, by the user computer, the media input to the user, wherein during playback of the media input to the user:
monitoring, by the user computer, for the trigger for each of the mediacard offers, and
displaying, by the user computer, each of the mediacard offers in response to detecting the trigger for each of the mediacard offers.

6. The method of claim 5, wherein the mediacard offer is displayed to the user for a predetermined period of time.

7. The method of claim 5, further comprising:
receiving, by the user computer, a user input to select the mediacard offer; and
sending, by the user computer, a mediacard request to the reconfigured media provider, the mediacard request including a user identifier and an image identifier associated with the mediacard offer, wherein the reconfigured media provider issues a mediacard to the user in response to the mediacard request.

8. The method of claim 5, wherein the trigger includes a trigger time.

9. The method of claim 5, wherein the trigger includes a manual input by a moderator of a live event.

10. The method of claim 5, wherein determining mediacard offers associated with the product identifier further comprises:
determining an event location associated with the product identifier;
determining a location of the user computer;
comparing the location of the user computer to the event location to determine if the user is present at the event location; and
if the user is present at the event location, determining mediacard offers associated with the product identifier including location-based mediacard offers.

11. A method comprising:
receiving, by a server computer, a trade request from a user computer, wherein the trade request includes a unique mediacard identifier that includes an image identifier;
identifying, by the server computer, a mediacard associated with the image identifier;
validating, by the server computer, that the unique mediacard identifier is associated with the mediacard;
determining, by the server computer, a value for the mediacard;
generating, by the server computer, a trading offer including the image identifier associated with the mediacard, the value of the mediacard, and the unique mediacard identifier; and
storing, by the server computer, the trading offer for the mediacard in a trading database.

12. The method of claim 11 further comprising:
searching, by the server computer, the trading database to identify mediacards associated with other users;
sending, by the server computer, the identified mediacards associated with other users to the user computer in a trade response;
receiving, by the server computer, a selection of at least one of the mediacards associated with the other users;
generating, by the server computer, an exchange request and sending the exchange request to an owner of the at least one selected mediacards;
receiving, by the server computer, an exchange response from the owner;
if the owner agrees to the exchange in the exchange response, generating replacement unique mediacard identifiers for the mediacard and the at least one selected mediacard; and
storing the replacement unique mediacard identifiers to the profiles of the user and the owner.

13. The method of claim 12, wherein generating replacement unique mediacard identifiers for the mediacard and the at least one selected mediacard includes exchanging the user identifiers for each of the mediacards.

14. The method of claim 11, wherein the mediacards associated with the other users comprise an equal or lesser value than the user's mediacard.

15. The method of claim 11, wherein the value of the mediacard is dependent on a performance of an entity associated the mediacard.

16. The method of claim 11, wherein the value of the mediacard changes over time.

17. The method of claim 11, wherein the value for the mediacard is further dependent on a total number of issued mediacards associated with the image identifier and an interest level associated with the mediacard.

18. The method of claim 11, wherein the value of the mediacards can be exchanged for coupons, goods, or services.

19. A method comprising:
receiving, by a user computer, two or more mediacards from a server computer;
displaying a first mediacard on a display screen of a user computer, wherein displaying the first mediacard includes displaying an image associated with an image identifier and a title on the display screen;
receiving, by the user computer, a swipe input from the user to display a second mediacard;
displaying the second mediacard on the display screen of the user computer;
receiving, by the user computer, a selection input from the user to select the second mediacard;
determining, by the user computer, a link to a media input associated with the second mediacard; and
sending, by the user computer, a request for the media input associated with the second mediacard using the link.

20. The method of claim 19, further comprising:
displaying an animation showing the second mediacard flipping over to show a backside of the mediacard, wherein the backside of the mediacard includes a mediacard player;
receiving the media input from a content provider server computer associated with the link; and
displaying the media input in the mediacard player displayed on the backside of the second mediacard.

21. A method comprising:
receiving, by a server computer, a request to generate a mediacard, the request including a type of mediacard, an image, and media content from a user computer;
determining, by the server computer, a link to a media input associated with the media content;
determining, by the server computer, mediacard effects associated with the type of mediacard;
generating, by the server computer, an image identifier associated with the mediacard;
storing, by the server computer, the mediacard in a mediacard database, the mediacard including the image, the image identifier, the media content, the link to the media input, and the mediacard effects; and
updating, by the server computer, a user profile of the user as being associated with the mediacard.

22. The method of claim 21, further comprising:
generating, by the server computer, a unique mediacard identifier associated with the user for the mediacard; and
storing, by the server computer, the unique mediacard identifier to the user profile of the user.

23. The method of claim 21, further comprising:
receiving, by the server computer, a selection of two or more mediacards as being associated with a mediacard story from the user computer, the mediacard story including a trigger condition;
monitoring, by the server computer, other users for actions that meet the trigger condition;
determining, by the server computer, that at least one of the other users meet the trigger condition; and
sending, by the server computer, the mediacard story to the at least one of the other users that meet the trigger condition.

24. The method of claim 21, wherein the trigger condition includes at least one of performing an action associated with the media input, traveling within a proximity of a predetermined geographic location, a performance or status of a user, and a playback time of a media input.

25. The method of claim 21, wherein the type of mediacard includes one of a video card, an audio card, an engagement card, a promotion card, an exclusive card, an personal card, and a profile card.

26. A computer-readable medium comprising code, executable by a processor, for performing the method of claim 1.

27. A server computer comprising:
a processor; and
the computer readable medium of claim 26.
